(19) United States
(12) Patent Application Publication
(10) Pub. No.: US 2018/0059919 A1
(43) Pub. Date: Mar. 1, 2018

(54) Responsive Design Controls

(71) Applicant: Adobe Systems Incorporated, San Jose, CA (US)

(72) Inventors: Samuel Suen Han Wan, Portland, OR (US); Stephanie M. Newcomb, Seattle, WA (US); Razvan Cotlarciuc, Seattle, WA (US); Paul H. Sorrick, Seattle, WA (US); Dana Kory Cooper, Seattle, WA (US); Colby Nels Ausen, Seattle, WA (US); Lance David Bushore, Seattle, WA (US); Jason Paul Prozora-Plein, Shoreline, WA (US); David E. Williamson, Woodinville, WA (US); David C. Stephens, Shoreline, WA (US); Abhishek Gulati, Seattle, WA (US)

(73) Assignee: Adobe Systems Incorporated, San Jose, CA (US)

(21) Appl. No.: 15/249,049

(22) Filed: Aug. 26, 2016

(51) Int. Cl. G06F 3/0484; G06F 17/21; G06F 3/0485

(52) U.S. Cl. CPC G06F 3/04847; G06F 17/212; G06F 3/04817; G06F 3/0485; G06F 3/04842

(57) ABSTRACT

Techniques for responsive design controls are described. A user interface is provided having a breakpoint bar configured to display multiple selectable breakpoints. When the breakpoints are selected, digital content displayed on a design surface located adjacent to the breakpoint bar is resized according to a relative size of the breakpoint. The user interface additionally has a central axis along which the multiple breakpoints are distributed. The design surface enables the digital content to be viewed and resized around the central axis responsive to selection of one of the breakpoints. Additional tools and techniques are provided to implement responsive design controls.

### BACKGROUND

The number of computing devices with differing sizes and form factors that are capable of displaying content is ever increasing. Users have options such as smartphones, tablets, laptop computers, desktops computers, television monitors, and large-scale projectors on which they can view content, to name a few examples. These display devices vary in size from one to another, but may also significantly vary in size within the same category of device. Users of these devices expect a page of content to resize automatically and gracefully from one device to another. However, this presents problems for content designers. Content designers are limited to designing content within constraints of either filling in boilerplate grid templates with content in a paint-by-numbers approach, or a Cascading Style Sheet (CSS) layout model. The CSS model requires the page structure to remain unchanged and different screen sizes, and requires the content designer to have a confident understanding of computer programming in order to make their ideas come to life. What is needed is a visual tool that gives designers complete freedom to create original content layouts that translate seamlessly between various display device sizes.

### SUMMARY

Techniques for responsive design controls are described. In one or more implementations, a user interface is provided having a breakpoint bar configured to display multiple selectable breakpoints and a design surface adjacent the breakpoints. The breakpoints are distributed along a central axis of the user interface. When the breakpoints are selected, digital content displayed on the design surface is automatically resized according to a relative size of the breakpoint. Additionally, content that was not visible in a previously displayed breakpoint may appear in a newly selected breakpoint, or some content that was visible in the previously displayed breakpoint may disappear when new breakpoint is selected. The design surface enables the digital content to be viewed and resized around the central axis responsive to selection of one of the breakpoints.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in accordance with one or more implementations.

FIG. 2 illustrates one example of current techniques for creating custom digital content.

FIG. 3 illustrates a user interface having a breakpoint bar and central axis configured to implement responsive design controls in accordance with one or more implementations.

FIG. 4 illustrates a user interface having a breakpoint bar configured to display an active breakpoint color in accordance with one or more implementations.

FIG. 5 illustrates a user interface having a breakpoint bar with a maximum-width toggle in accordance with one or more implementations.

FIG. 6 illustrates a user interface having a breakpoint bar with a minimum-width indicator in accordance with one or more implementations.

FIG. 7 illustrates a user interface having a breakpoint bar with at least one fluid breakpoint in accordance with one or more implementations.

FIG. 8 illustrates a user interface having a breakpoint bar with at least one fixed breakpoint in accordance with one or more implementations.

FIG. 9 illustrates a user interface configured to implement resizing and pinning controls in accordance with one or more implementations.

FIG. 10 illustrates a user interface displaying an item of content to which a Responsive Width resize control has been applied in accordance with one or more implementations.

FIG. 11 illustrates a user interface displaying an item of content to which a Responsive Width and Height resize control has been applied in accordance with one or more implementations.

FIG. 12 illustrates a user interface displaying an item of content to which a Stretch to Browser Width resize control has been applied in accordance with one or more implementations.

FIG. 13 is a diagram depicting example pinning controls in accordance with one or more implementations.

FIG. 14 illustrates a user interface displaying an item of content that has been pinned to a page in accordance with one or more implementations.

FIG. 15 illustrates a user interface displaying an item of content that has been pinned to a page in accordance with one or more implementations.

FIG. 16 illustrates a user interface displaying an item of content that has been pinned to a page in accordance with one or more implementations.

FIG. 17 illustrates a user interface displaying an item of content that has been pinned relative to a browser window in accordance with one or more implementations.

FIG. 18 illustrates a browser window displaying a page comprising an item of content that has been pinned relative to the browser window.

FIG. 19 is a diagram depicting example formatting controls in accordance with one or more implementations.

FIG. 20 illustrates a user interface displaying an item of content that has been selected to have a characteristic applied to multiple breakpoints in accordance with one or more implementations.

FIG. 21 illustrates a user interface displaying an item of content that has been selected to have a characteristic applied only to the current breakpoint in accordance with one or more implementations.

FIG. 22 illustrates a user interface displaying an item of content that has been selected to be made the same across multiple breakpoints in accordance with one or more implementations.

FIG. 23 illustrates a user interface displaying an item of content that has been selected to be made the same on a selected additional breakpoint in accordance with one or more implementations.

FIG. 24 illustrates a user interface and a browser window displaying an item of content to which a scroll effect has been applied in accordance with one or more implementations.

FIG. 25 illustrates a user interface and a browser window displaying an item of content to which a scroll effect has been applied in accordance with one or more implementations.

FIG. 26 illustrates a delaying changes to items of content in a breakpoint that is not currently being viewed in accordance with one or more implementations.

FIG. 27 illustrates different options for copying items of content across different websites as the websites are being created or edited in accordance with one or more implementations.

FIG. 28 illustrates a master page breakpoint inheritance indicator in accordance with one or more implementations.

FIG. 29 illustrates a user interface displaying an item of content and a warning that the item of content will be cropped in accordance with one or more implementations.

FIG. 30 is a flow diagram that describes details of an example procedure which includes responsive design controls in accordance with one or more implementations.

FIG. 31 is a flow diagram that describes details of an example procedure which includes responsive design controls in accordance with one or more implementations.

FIG. 32 is a flow diagram that describes details of an example procedure which includes responsive design controls in accordance with one or more implementations.

FIG. 33 is a flow diagram that describes details of an example procedure which includes responsive design controls in accordance with one or more implementations.

FIG. 34 is a block diagram of a system that can include or make use of responsive design controls in accordance with one or more implementations.

### DETAILED DESCRIPTION

### Overview

Techniques described herein provide solutions to content designers when creating original content layouts for display devices of different sizes. In one implementation, a user interface is provided having a breakpoint bar. The breakpoint bar displays one or more breakpoints, which are selectable to cause digital content to be resized, repositioned, shown, and/or hidden. The breakpoints represent set widths at which content will be displayed on various devices. When the breakpoints are selected on the breakpoint bar, the content is resized, repositioned, shown, and/or hidden according to the corresponding size of the breakpoint.

The user interface also has a central axis relative to which the multiple selectable breakpoints are distributed. In one or more implementations, the breakpoints are aligned around the central axis and displayed in a layered fashion such that the smallest breakpoint is in the forefront of the breakpoint bar, the next largest breakpoint is underneath the smallest breakpoint, but is visible because it extends beyond and out from under the smallest breakpoint, and so on.

In addition, the user interface has a design surface adjacent the breakpoint bar for creating digital content. The design surface enables the digital content to be viewed and resized around the central axis responsive to selection of an individual breakpoint. This is in contrast to current techniques, which align content to the left of a design surface causing elements to “jump” around relative to the computer screen when the surface is resized, which is undesired in certain situations. When the elements jump in such a manner, the human eye must reorient its focus relative to the edge of the page in order to continue looking at the same element. On the other hand, automatically centering content on the design surface makes it easier for the human eye to track layout changes as a content designer simulates different device or browser sizes. Further, existing tools that rely on CSS alone do not allow for page structures that are able to satisfy multiple designs having multiple, separate breakpoints.

Additionally provided in the user interface are controls for resizing and pinning digital content items displayed on a page within the design surface. The resize control provides options for resizing a selected item of content in relation to a width of the page in the design surface or in a browser. For example, one such control is a “Responsive Width” control. If a user chooses the “Responsive Width” control for an item of digital content, the width of the item of content will change proportionally to the page when the page is resized. In another example, if the user chooses a “Responsive Width and Height” control for an item of digital content, the item of digital content will change in overall size (i.e. width and height) proportionally, responsive to the page being resized. Additional implementations of resize controls are discussed in more detail below.

In one or more implementations, two pinning controls are provided in the user interface. A pinning control allows a user to select a location on a page from which an item of content will maintain a set distance. A first pinning control displays an icon that is representative of a page having custom digital content. The first pinning control has points on an icon that are selectable by a user to pin an item of digital content to the page. When the user selects one of these points, the item of digital content will remain a set distance from the selected point on the icon. For example, if the user selects a left icon on the first pinning control, the item of digital content will maintain the same distance between the left side of the page and the item of content, regardless of the size of the page, when the page is displayed by an application, such as a browser. However, all other dimensions surrounding the item of content will change accordingly between the sides of the page and the item of content.

A second pinning control displays an icon that is representative of an application window, e.g., a browser window, to display the custom digital content. Similar to the first pinning control, the second pinning control has points on an icon that are selectable by a user to pin an item of content. However, in this case, the item of digital content will remain a set distance from a selected point on the icon relative to the application window, e.g., browser window. For example, if the user selects a top-right icon on the second pinning control, the selected item of digital content will maintain the same distance between the top of the browser and the right side of the browser when the content is previewed in the browser. This distance will be maintained even when the user scrolls up, down, left, or right in the browser window.

The combination of resizing and pinning items of digital content can handle most resizing behaviors a designer would expect as a page layout grows and shrinks. In addition, items of digital content can have totally different behaviors as the size of a browser window on a display device changes, particularly when combined with the techniques involving multiple breakpoints that are discussed above and below. These approaches, especially when combined, allow designers to “think” in visual terms, rather than constraint terms, and obviate the need for a complex and time-consuming CSS model of design.

The user interface may also provide a toggle for selectively applying characteristics or properties to an item of digital content. Characteristics or properties can be applied either only within a current breakpoint, or across more than one breakpoint. For example, a user may select an item of digital content, such as a block of text, which is displayed in the design surface. The user may then select a mode of the toggle which will cause a subsequently applied characteristic to be applied the block of text across all of the breakpoints that the user has created. Next, the user may apply a characteristic to the block of text, such as a three-dimensional effect. This will cause the same block of text to have the three-dimensional effect applied in each and every breakpoint, without the user having to manually change the block of text to have the characteristic in each of the breakpoints. The user can also select the alternate mode of the toggle, and the next subsequently applied characteristic will be applied to the block of text only in the currently-displayed breakpoint, without being applied to all of the breakpoints that are not currently displayed.

The toggle allows the user to specify whether formatting changes will be applied across all breakpoints, or only a current breakpoint. This toggle allows the user to continue working with known formatting controls, without requiring them to think of side-effects between breakpoints or hierarchies of CSS styles and hierarchies of HTML elements at different breakpoint levels.

In the discussion that follows, a section titled “Operating Environment” is provided that describes one example environment in which one or more implementations can be employed. Next, a section titled “Responsive Design Controls” describes example details and procedures in accordance with one or more implementations. Following this, a section titled “Example Procedures” describes procedures in accordance with one or more implementations. Last, a section titled “Example System” describes example computing systems, components, and devices that can be utilized for one or more implementations of responsive design controls.

### Operating Environment

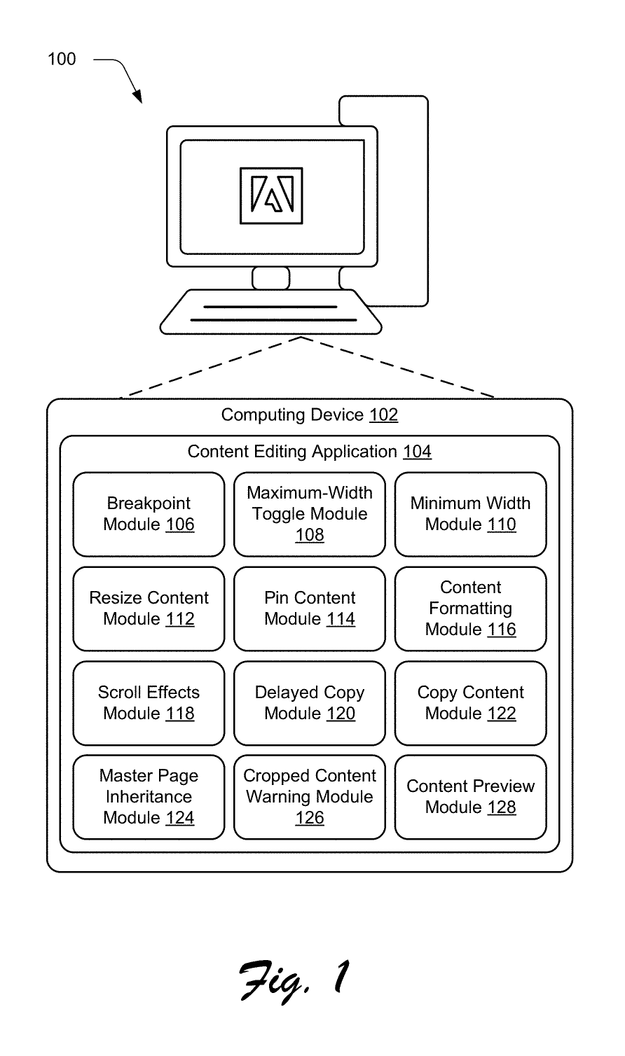

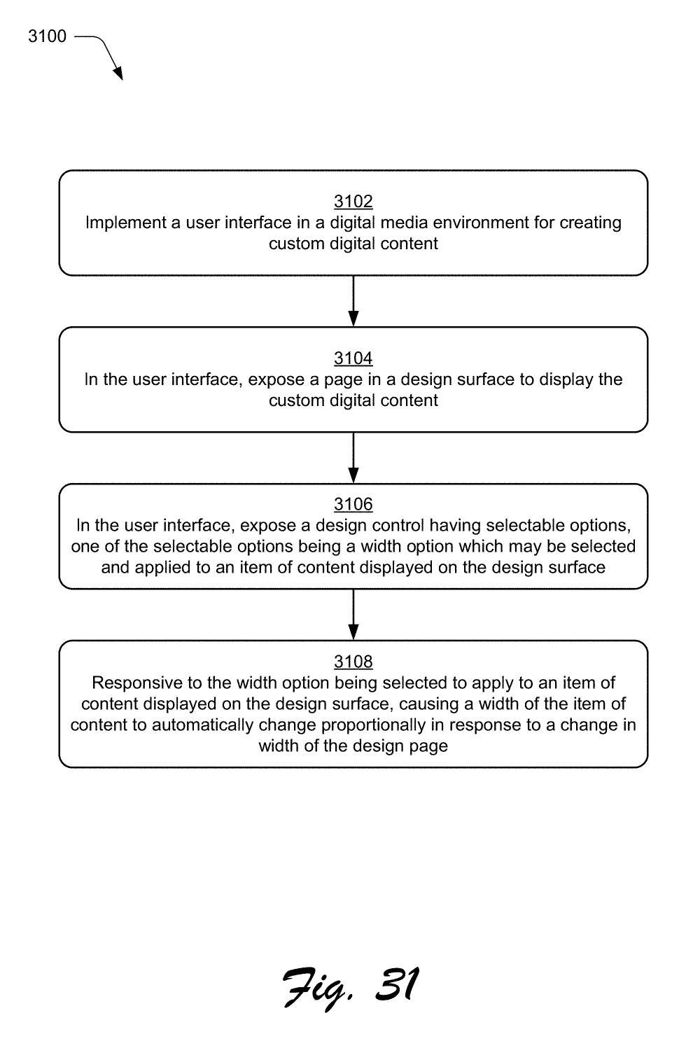

FIG. 1 illustrates an operating environment, generally at 100, in accordance with one or more implementations for responsive design controls. The environment includes a computing device 102 having a content editing application 104 with modules 106-128 that reside on computer-readable media of the computing device 102, and are executable by a processing system of the computing device 102. Examples of processing systems and computer-readable media which may be implemented in the computing device 102 can be found in the discussion of the example computing system of FIG. 31.

The content editing application 104 of the computing device 102 may be provided using any suitable combination of hardware, software, firmware, and/or logic devices. The content editing application 104 represents functionality operable to create and/or edit digital content. For instance, the content editing application may be configured as a website creation and editing application which allows designers to create websites or other content to be displayed on a display device without having to write code. Other content to be displayed on a display device may include device application interfaces, e-books, blogs, or digital publications, to name some examples. Creating and editing digital content may include editing and rendering text, editing digital documents using vector graphics, displaying and editing three-dimensional graphics, editing digital images, and editing videos, to name a few examples. Alternatively or additionally, the content editing application 104 may comprise part of one or more other applications, such as word processing applications, social networking applications, applications for business management, or software development applications, for example.

The various modules 106-128 are configured to implement a number of functionalities for responsive design controls. Breakpoint module 106 represents functionality operable to enable creation, display and manipulation of multiple breakpoints as part of creating and editing digital content. As discussed herein, a breakpoint is a representation of a defined size within which content on a page follows a particular set of rules. When the size of the page transitions from one breakpoint to another breakpoint, behavior of the content changes to adhere to rules associated with the current breakpoint. The breakpoint module 106 causes the display of one or more breakpoints in a breakpoint bar in a user interface of the content editing application 104. When multiple breakpoints are displayed in the breakpoint bar, the breakpoints are aligned on a central axis and displayed in a layered fashion such that the smallest breakpoint is in the forefront of the breakpoint bar, the next largest breakpoint is underneath the smallest breakpoint but is visible because it extends beyond the smallest breakpoint, and so on. The breakpoints thus increase in size as the breakpoints decrease in layers.

The breakpoint module 106 additionally represents functionality to cause an active breakpoint to be displayed in a color such that the active breakpoint is emphasized to a user. An active breakpoint is a breakpoint associated with content that is currently being edited or created in a design surface for the defined size of the breakpoint. The breakpoint module 106 may be configured to cause each breakpoint of multiple breakpoints in the breakpoint bar to have a different active breakpoint color. Additional details regarding the active breakpoint color are discussed below.

Further, the breakpoint module 106 represents functionality to enable the mixture of fixed and fluid breakpoints on a page. A fixed breakpoint generally maintains a constant size of content displayed within a size range associated with the breakpoint, even if the size of the page changes within the size range of the breakpoint. On the other hand, a fluid breakpoint generally resizes content proportionally when the page is resized. Therefore, the breakpoint module 106 is capable of having a fixed breakpoint for a largest size range of a page, a fluid breakpoint for a smaller size range of the page, followed by another fixed breakpoint for a smallest size range of the page, to give but one illustrative example.

The maximum-width toggle module 108 represents functionality to implement a toggle that controls behavior of content when the size of an application window, such as a browser window, is increased beyond a defined maximum width. In one implementation, one mode of the maximum-width toggle can be selected to cause content in the browser to continue to grow proportionally as the browser is resized beyond a defined maximum width. Another mode of the maximum-width toggle can be selected to cause content in the browser to remain the same size as the browser is resized beyond a defined maximum width, with a border to accommodate the increase in size of the browser beyond the maximum width.

The minimum width module 110 represents functionality to control how content behaves when the size of a browser becomes smaller than a defined minimum width. This may include indicating a minimum width in a breakpoint bar, and/or enabling a preview of how content will appear in a browser when the browser is resized to be smaller than the minimum width. In one or more implementations, the minimum width module 110 is configured to crop a visual representation of the content in a design surface that is resized to smaller than the minimum width. Consequently, a web browser may display horizontal scroll bars when the size of the browser window is smaller than the minimum width to allow a user to navigate view of the entire page.

The resize content module 112 represents functionality to provide options for resizing a selected item of content in relation to a size of a page containing the item of content. For example, if a user chooses a “Responsive Width” control for an item of digital content, this causes the width of the item of digital content to change proportionally to the page when the page is resized. In another example, if the user chooses a “Responsive Width and Height” control for the item of digital content, the item of digital content will change in overall size proportionally responsive to the page being resized. Additional implementations of resize controls are discussed in more detail below.

The pin content module 114 represents functionality to provide two pinning controls. A first pinning control has points on an icon that are selectable to pin an item of content relative to the page on which the item of content is displayed. For example, if a user selects a right-side point on the icon while an item of content is selected, the item of content will maintain the same distance from the right side of the page as the size of an application window displaying the page grows or shrinks. However, because the pin in this instance is relative to the page, scrolling the page in the application will not affect the behavior of the item of content with respect to the distance from the side of the application window. Further, pinning the item of content to the right side of the page will only maintain the distance between the item of content and the right side of the page, and all other dimensions will change proportionally as the page is resized in the application window.

The pin content module 114 also provides a second pinning control that has points on an icon that are selectable to pin an item of content relative to a browser window when the content is viewed in an application. For instance, a user may select a bottom-left point on the icon while an item of content is selected. The item of content will keep the same distance from the bottom-side and left-side of the application window when previewing a page in the application. In this case, the pinning takes place relative to the application window, so scrolling in the application will result in the item of content staying in the same position relative to the application window, rather than moving with the rest of the content on the page as the page is scrolled. The pin content module 114 is further configured to combine the functionalities of the two pinning controls to provide a variety of behaviors for page content as a page displayed in an application, such as a browser, is resized and scrolled.

The content formatting module 116 represents functionality to selectively apply formatting to items of content across breakpoints. In one implementation, the content formatting module 116 is configured to display options to a user that allow a user to copy the size and position of an item of content across all breakpoints, or copy the size and position of an item of content to a selected breakpoint of multiple breakpoints. In another implementation, the content formatting module 116 is configured to implement a toggle, where one mode of the toggle applies formatting properties to a selected item of content only in the currently-displayed breakpoint. Another mode of the toggle, when selected, applies formatting properties to a selected item of content across multiple breakpoints. In yet another implementation, the content formatting module 116 may be configured to provide a selectable option to copy text formatting to another particular breakpoint or to all of the breakpoints for the page. As described herein, formatting operations performed by the content formatting module 116 may include options such as color, border, font face, and/or font size, along with properties corresponding to the position of an item of content on the page.

Further, the content editing application 104 comprises a scroll effects module 118. Scroll effects cause an item of content to change or move in a particular way when a page is scrolled, beyond simply moving with the page as the page is scrolled in a browser. Other scroll effects may include changing an item of content's background image location; changing opacity of the item of content; rotation of the item of content; starting, pausing, and/or stopping an item of content such as a movie, slideshow, or animation; or linking a movie, slideshow, or animation to the vertical scroll bar, as if the vertical scroll bar becomes its timeline. The scroll effects module 118 represents functionality to apply different scroll effects in different breakpoints. For example, a page displayed in a browser falling in a size range of a small breakpoint may have a first scroll effect, while a page displayed in a browser falling in a size range of a large breakpoint may have a second, different scroll effect.

Additionally, the content editing application 104 comprises a delayed copy module 120. The delayed copy module 120 is configured to document changes that are made to the page within the currently viewed breakpoint, and copy the documented changes to a different breakpoint only when the different breakpoint is selected for viewing. In an example, a user may be designing a page with two breakpoints, a first breakpoint being 1000 pixels wide and a second breakpoint being 500 pixels wide. The user may begin editing content on the page in a design surface corresponding to the first breakpoint by creating a rectangle on the page having a width of 300 pixels. The user may perform other actions to edit the page, such as creating other content, moving content, resizing content, or changing characteristics or properties of content. Indications of these changes and actions will be stored by the delayed copy module 120, but will not be implemented on the second breakpoint until the user selects the second breakpoint for viewing in the design surface. In this example, when the user selects the second breakpoint, the rectangle that was created in the first breakpoint will appear with a corresponding width of 150 pixels.

The content editing application 104 also comprises a copy content module 122. The copy content module 122 provides users with different copy-paste options when moving content from one document to another. These copy-paste options include, but are not limited to, creating missing breakpoints when content items are copied from one document to another, ignoring missing breakpoints when content items are copied, or matching to the closest breakpoint when content items are copied. In an example of matching to the closest breakpoint, an item of content having a width of 500 pixels may be copied from a first document which was designed at a breakpoint having a size of 1000 pixels. When the item of content is pasted into another document on a breakpoint 800 pixels in size, the copy content module is configured to resize the item of content to be 400 pixels. Additional examples of functionality provided by the copy content module 122 are provided below.

The content editing application 104 further comprises a master page inheritance module 124. Generally, a master page is a page that holds items of content that will be applied to multiple pages of a website, for example. In one implementation, a master page may comprise items of content such as a company logo and a navigation menu that are meant to be identical for all pages on a website. This functionality is achievable without utilizing master pages, but designers will have to duplicate each of these items on every page of a website they are creating. Moreover, if the designer needs to make edits to one of these items, the designer will need to visit each page to make the changes. Using a master page allows the designer to only have to create and edit these content items in one place, reducing working time and eliminating potential errors.

Similar to other pages described herein, master pages may have more than one breakpoint. A user may create a new page (in this example, not a master page) that uses a master page to reference and display content items from the master page. The master page may have two breakpoints, one at 1000 pixels and another at 500 pixels. However, the new page may only have one breakpoint at 1000 pixels. The master page inheritance module 124 is configured to display an indicator in the breakpoints bar of the new page to indicate that the master page has a breakpoint at 500 pixels, but the new page does not have this breakpoint. The master page inheritance module 124 may also be configured to allow the user to select the indicator, such as by a mouse click or touch input, which will cause a scrubber to jump to the exact size of the missing breakpoint at 500 pixels. When the scrubber is at this location, the user may easily and quickly create a breakpoint on the new page to match the size of the breakpoint on the master page. Additional details regarding master page inheritance are described below.

Furthermore, the content editing application 104 comprises a cropped content warning module 126, representative of functionality to provide warnings when an item of content may be cropped because it overlaps a boundary of a breakpoint. In an example, an item of content may slightly overlap the boundary of a breakpoint when a user is creating a webpage. In previous scenarios, the user may not have been aware that the item of content overlapped the boundary, resulting in an undesired display or behavior of the page layout when the page is displayed on certain devices. This may include causing content to fall outside of the viewing area where it cannot be reached or viewed, or forcing the browser to display a horizontal scroll bar which may not be desirable. To prevent this from happening, the cropped content warning module 126 provides a visual indicator on an item of content that exceeds a boundary of a breakpoint. The cropped content warning module 126 may further display an overlay on the portion of the item of content that exceeds the boundary of the breakpoint. This can give a user a visual indication of how the item of content may be cropped when displayed in a browser of a device falling into the size range of the breakpoint.

Finally, the content editing application 104 comprises a content preview module 128. The content preview module is representative of functionality to accurately preview digital content that is created and edited in the content editing application 104. In one or more implementations, the content preview module 128 is configured to display a design surface as described above and below, where the design surface corresponds to how a page will be displayed in a browser. In order to accurately display the design surface corresponding to how a page will be displayed in a browser, the content preview module 128 presents the design surface according to the size of a selected breakpoint. Because breakpoints may represent a range of sizes of potential displays, the content preview module 128 further comprises a scrubber tool which is configured to resize the design surface more incrementally than simply selecting different breakpoints in a breakpoint bar. The scrubber tool may resize the design surface within a selected breakpoint, and/or may resize the design surface from one breakpoint to another. While the scrubber tool is resizing the design surface, the content preview module 128 accurately resizes and changes items of content in the design surface according to rules, characteristics, location, and properties associated with items of content on the page.

The content preview module 128 is also configured to generate previews of a browser window, simulating a browser window that may display pages created by the user. Previews of a browser window created by the content preview module 128 may have elements similar to a typical browser window, such as an address bar, vertical and horizontal scroll bars, and a display window to display pages created by the user. When previewing a page in a browser window, the content preview module 128 again accurately resizes and changes items of content in the design of the page according to rules, characteristics, and properties associated with items of content on the page. However, previewing the page in a browser window may give the user a more realistic expectation of how their design will behave when published as a webpage, for instance.

Having described an example operating environment, consider now example details and techniques associated with one or more implementations of responsive design controls.

Responsive Design Controls

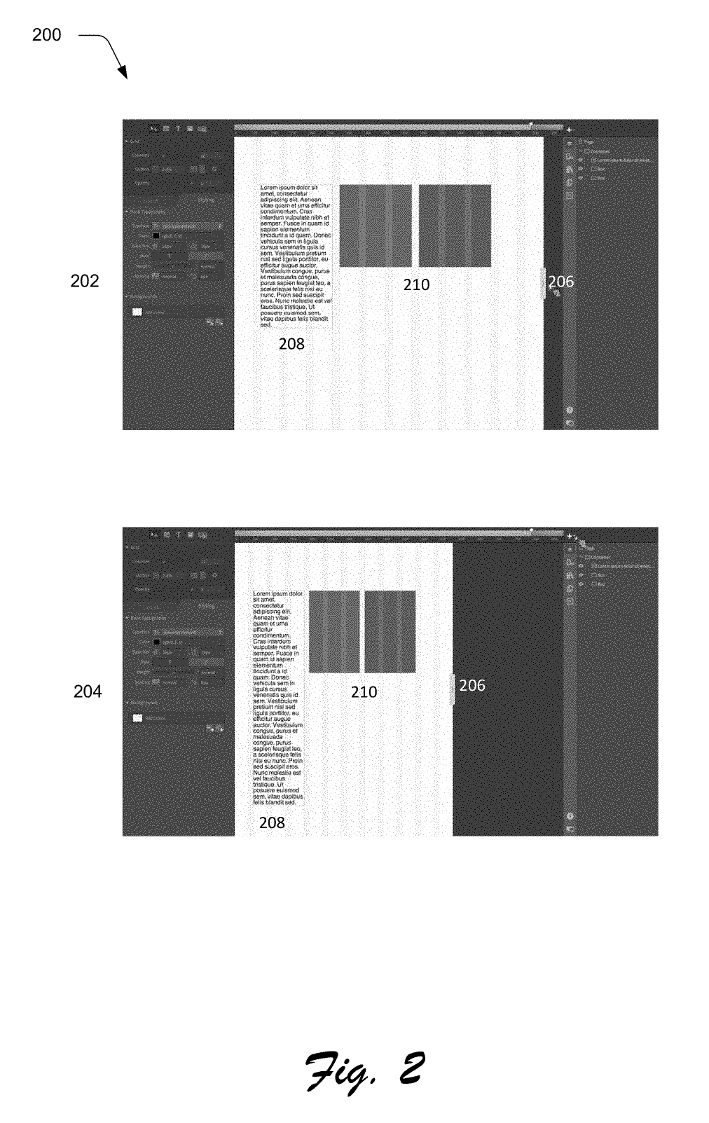

Responsive design controls provide numerous advantages over current techniques for creating and editing digital content. Before discussing these advantages in greater detail, consider one embodiment of an example user interface for creating web pages depicted in FIG. 2, which is representative of some current techniques. FIG. 2 depicts a user interface, generally at 200, for creating and editing digital content such as web pages. In the representation of the user interface at 202, a web page is displayed in the user interface at a first size. The first size represented at 202 depicts how content will appear on the page when the page is displayed in a browser window of approximately the same size. A scrubber 206 may be used to resize the page and can enable a preview, in the user interface, of how the page will appear when it is displayed in browser windows of different sizes. While the scrubber 206 is depicted on the right side of the page in the user interface, embodiments are contemplated in which the scrubber is located on the left side of the page, or on both the left and right sides of the page in order to provide resizing functionality at these locations. The depicted web page comprises a text block 208 and items of content 210, which will appear when the page is displayed in a browser.

Moving to the representation of the user interface at 204, the scrubber 206 has been selected and moved to resize the page to a second, smaller size. Similar to the first size described above, the second size represented at 204 depicts how content will appear on the page when the page is displayed in a browser window of approximately the same size. However, with this smaller page, the text block 208 has been compressed horizontally and expanded vertically in order to accommodate all of the text in the text block. Similarly, the content items 210 have been compressed horizontally as the size of the page shrinks. In other words, the text block 208 and the content items 210 grow and shrink from the left side of the page. One can easily imagine how certain items of content, such as photographs, videos, or animations, can be distorted when resized in this manner.

This embodiment uses a left-aligned artboard to create and edit digital content. When a left-aligned artboard is resized, it can not only cause the difficulties described above, but it can also cause elements on a page to “jump” around relative to a display screen. When elements jump around on a display screen, the human eye must reorient its focus relative to the edge of the page in order to continue looking at a same element. These problems can cause disorientation, and even nausea, during usability tests of left-aligned artboards. Through the techniques described in relation to responsive design controls, these problems can be alleviated or eliminated altogether.

### Centered Breakpoints

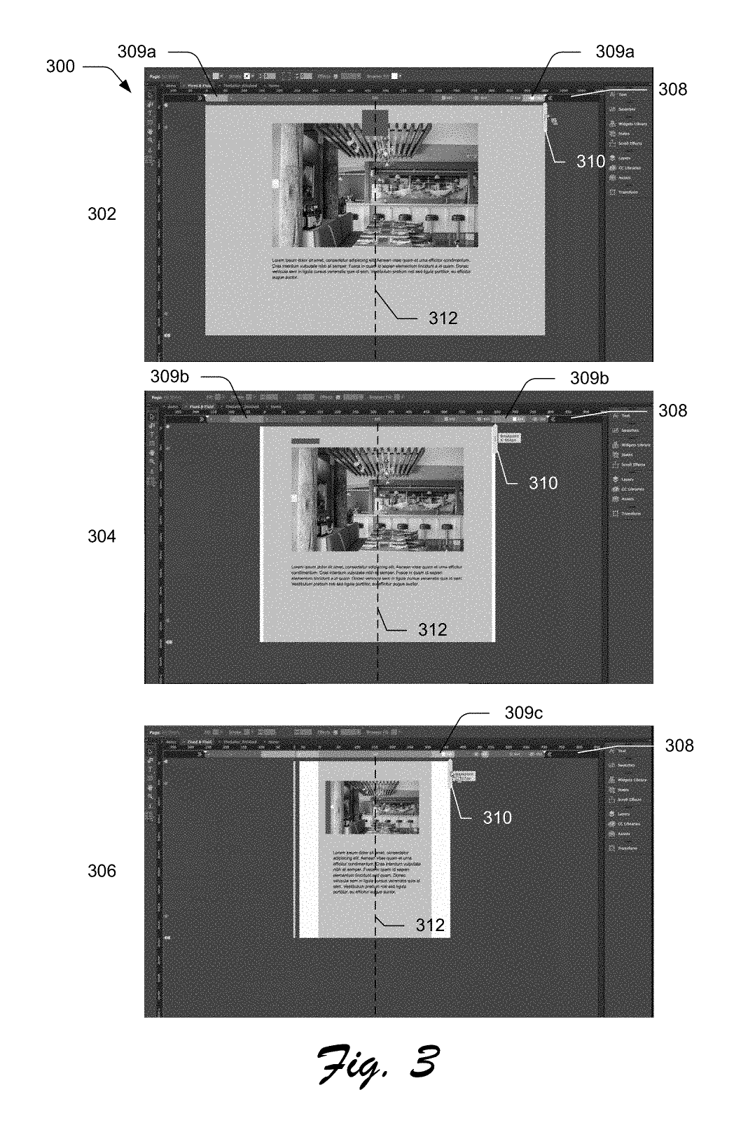

FIG. 3 illustrates a user interface configured to implement responsive design controls in accordance with one or more embodiments, generally at 300. The user interface has three different representations 302, 304, and 306 and may implement various controls and input mechanisms which allow users to create and edit digital content. The user interface may be configured as part of a content editing application, such as the content editing application 104 of FIG. 1. The user interface illustrated at 300 has a breakpoint bar 308 which can display one or more breakpoints. Here, two selectable regions of one breakpoint are shown at 309(a), which correspond to a size range within which content on a page will adhere to a particular set of rules. The breakpoints in the breakpoint bar 308 represent set widths at which content will be displayed on various devices. For example, the representation of the user interface at 302 displays a large instance of digital content that a user may be constructing corresponding to breakpoints 309a. This large instance displayed at 302 may represent a layout for a page which will be displayed on a desktop monitor. A scrubber 310 may be provided which allows a user to resize the page using a select-and-drag input on the scrubber 310, although other techniques for resizing the page are considered.

Also displayed overlaying the user interface at 302 is a central axis 312 representing a center alignment of the content displayed on the page in the active breakpoint. The center axis 312 is displayed in FIG. 3 only as a reference of how content may move about a central axis in connection with techniques described herein, and is typically not displayed in the user interface. However, in some scenarios, the central axis 312 may be displayed such as when an element is selected that has been pinned to the center of the page (described in more detail below). The dashed line representing the central axis 312 may be relative to an application displaying the page on a device, or may be relative to the design surface in the user interface when creating or editing the page. As the scrubber 310 is dragged from the position indicated in the representation of the user interface at 302, to the position indicated in the representation of the user interface at 304, the page is resized accordingly. Resizing the page in this manner may cause the layout to transition to another breakpoint in the breakpoint bar 308.

Transitioning to another breakpoint may cause the layout of the page to change from the large layout depicted in the representation of the user interface at 302 to a different, smaller layout depicted in the representation of the user interface at 304. Two selectable regions of this smaller breakpoint are shown at 309(b). This smaller layout depicted in the representation of the user interface at 304 could represent how the content will be displayed on a tablet device, for example. However, even though the browser is resized and enters a size range of another breakpoint, the content on the page remains aligned centrally about the central axis 312. Further, the central axis 312 remains fixed relative to a display screen or browser window that is displaying the page.

Similarly, as the scrubber 310 is dragged from the position indicated in the representation of the user interface at 304 to the position indicated in the representation of the user interface at 306, the page is resized accordingly but the content on the page remains aligned centrally about the central axis 312. In other words, the content in the user interface grows and shrinks relative to the central axis 312. Further, the content on the page remains aligned centrally about the central axis regardless of whether the currently-displayed breakpoint is fluid or fixed, which is discussed in more detail below. Centering the page automatically in this manner makes it easier for the human eye to track layout changes as a user simulates different browser sizes. In the representation of the user interface at 306, a single selectable region is shown at 309(c), because this is the smallest of the breakpoints and thus corresponds to the top layer of the breakpoints for the current page.

Not only is the content on the design surface aligned along the central axis 312, but the breakpoints in the breakpoint bar 308 are also aligned along the same central axis 312. In one or more implementations, the breakpoints are displayed in a layered fashion such that the smallest breakpoint 309(c) is in the forefront of the breakpoint bar, the next largest breakpoint is underneath the smallest breakpoint but is visible by how far it extends beyond the smallest breakpoint, and so on until the largest breakpoint, 309(a) in this case, which makes up the bottom layer of breakpoints. The breakpoints thus increase in size as they descend in layers. Each breakpoint consequently has a pair of selectable regions, all except the smallest breakpoint (e.g., 309(c)) which has an undivided selectable region in the forefront of all of the breakpoints. This allows for a user to select the breakpoints on either side, and have the content on a design surface adjacent the breakpoint bar be positioned and sized along the central axis corresponding to the selected breakpoint.

Having considered creating and editing digital content using centered breakpoints, consider now breakpoints and how active breakpoint color can be used to indicate different breakpoints to allow for efficient navigation by a user throughout the breakpoints in accordance with one or more embodiments.

Active Breakpoint Color

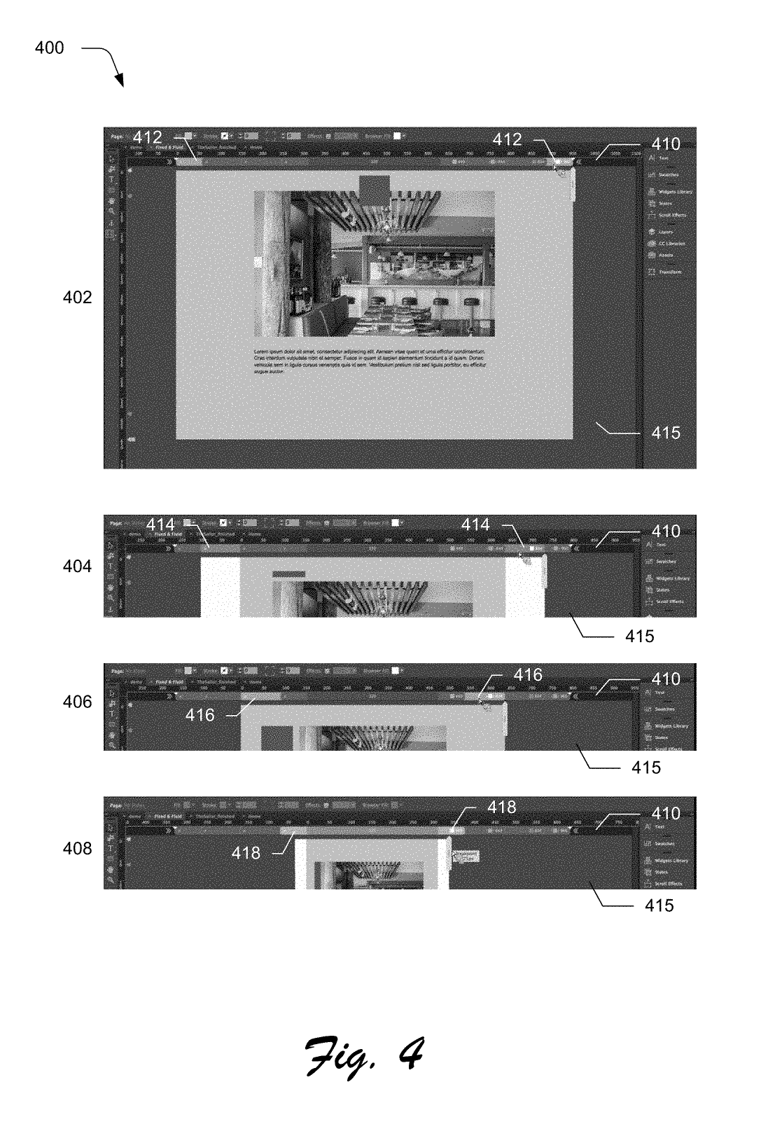

FIG. 4 illustrates a user interface, generally at 400, such as the user interface of FIG. 3, configured to implement responsive design controls in accordance with one or more embodiments. The user interface illustrated in FIG. 4 may have any or all of the functionalities of responsive design controls described herein. The user interface illustrated at 400 has a breakpoint bar 410 having multiple selectable breakpoints. Each breakpoint may represent a size range of displays, where a user may want content on a page to have different behaviors when displayed on different sized devices. For example, a large size range of displays represented by a first breakpoint may correspond to how content will behave and appear on a desktop computer monitor. A smaller size range of displays represented by a second breakpoint may correspond to how content will behave and appear on a tablet device. An even smaller size range of displays represented by a third breakpoint may correspond to how content will behave and appear on a mobile phone. Other examples are also contemplated, as the size ranges and functionality of devices is ever increasing.

The representation of the user interface at 402 displays selectable regions of an active breakpoint 412, along with content being edited or created by a user in design surface 415. The active breakpoint 412 is a breakpoint associated with content that is currently being edited or created in the design surface 415 for the defined size of the breakpoint. In this instance, the active breakpoint 412 corresponds to a large display device, and the content on the design surface 415 displays how the content will appear on a large display falling into the size range of the breakpoint 412. The active breakpoint 412 may be displayed in a color such that the active breakpoint is visually emphasized to a user. In one or more implementations, the active breakpoint 412 can have its own distinctive color that is unique from the other multiple breakpoints in the breakpoint bar 410. For example, breakpoint 412 can be purple, while the other breakpoints, when active, can be a different color. When the breakpoint 412 is active, the selectable regions of the breakpoint 412 are displayed in purple. As discussed above, each breakpoint (other than the smallest breakpoint) has a pair of selectable regions that correspond to how far the corresponding layer extends beyond the size of the breakpoint in the above layer. Additionally, when the breakpoint 412 is active, the other breakpoints may be displayed in a neutral color, such as gray, such that the active breakpoint color is visually emphasized to the user.

The representation of the user interface at 404 illustrates a portion of the user interface, including the breakpoint bar 410. In this representation of the user interface at 404 however, breakpoint 414 is selected as an active breakpoint, which may correspond to a slightly smaller display device such as a laptop computer. Again, the content on the design surface 415 (though not entirely pictured) reflects how the content will appear on a display falling into the size range of the breakpoint 414. In this example, the breakpoint 414 can be blue in contrast to the purple color of breakpoint 412. When breakpoint 414 is active, the selectable portions of the breakpoint are displayed in blue, with the other breakpoints, including breakpoint 412, displayed in a neutral color.

Similar breakpoint behavior occurs in the representation of the user interface illustrated at 406. At the user interface representation depicted at 406, breakpoint 416 is selected as the active breakpoint. The breakpoint 416 may correspond to an even smaller display device, such as a tablet or slate device. The content on the design surface 415 (not entirely pictured) displays how the content will appear on a display falling into the size range of the breakpoint 416. The breakpoint 416 in this example can be aqua. When the breakpoint 416 is active, the selectable portions of the breakpoint 416 are displayed in aqua, with the other breakpoints, including breakpoints 412 and 414 displayed in a neutral color.

The user interface representation illustrated at 408 has generally the same breakpoint behavior as described above. The breakpoint 418 may correspond to the smallest range of devices on which a user will display their content, such as mobile phones and/or a wearable device, to name a few examples. The content on the design surface 415 (not entirely pictured) displays how the content will appear on a display falling into the size range of the breakpoint 418. The breakpoint 418 in this example can be green. However, because this is the smallest of the breakpoints in the current design, when the breakpoint 418 is selected, the active breakpoint color green is visible for the entire length of the breakpoint. The other breakpoints 412, 414, 416, and 418 are displayed in a neutral color.

In one or more implementations, the breakpoints that are not active may include a small indicator of the breakpoints' unique color. However, when the breakpoints are not active, the majority of the selectable regions of non-active breakpoints are still displayed in a neutral color, so that the user can easily identify which breakpoint is active. For instance, when breakpoint 418 is the active breakpoint, breakpoint 412 may have a small purple indicator, breakpoint 414 may have a small blue indicator, and breakpoint 416 may have a small aqua indicator. These indicators provide a user with a quick reference guide to breakpoints as the user creates and edits the digital content of the user's design. Additionally, when a user creates new breakpoints, a module such as the breakpoint module 106 may automatically choose a unique color that does not overlap with an existing color for new breakpoints, keeping each of the breakpoints distinguishable from each other.

While examples provided herein describe a limited number of breakpoints, size ranges, types of display devices, and color choices, these examples are not intended to be limiting, and one skilled in the art will appreciate the numerous capabilities and variations of the described techniques.

Having considered the use of active breakpoint colors to indicate different breakpoints for efficient navigation by a user throughout the breakpoints, consider now a toggle to control how content will behave when a size of a page extends beyond a designated maximum width.

### Max-Width Toggle

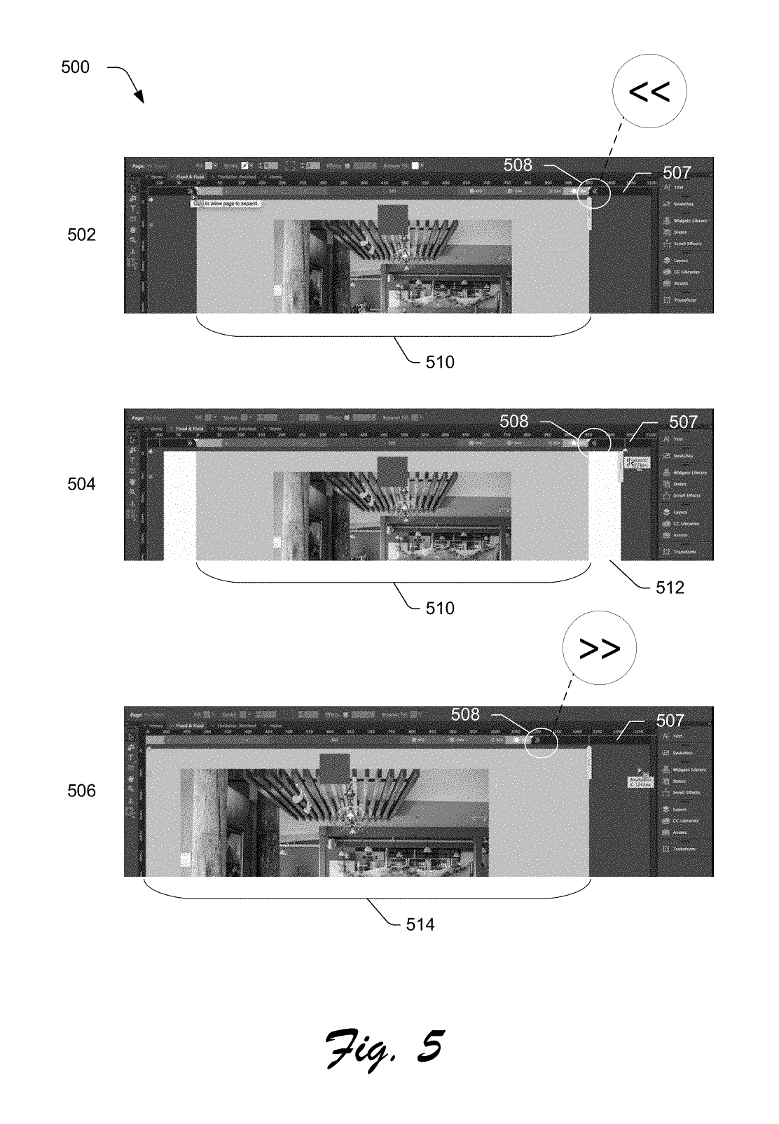

FIG. 5 illustrates a user interface, generally at 500, such as the user interface of FIG. 3, configured to implement responsive design controls in accordance with one or more embodiments. The user interface illustrated in FIG. 5 may have any or all of the functionalities of responsive design controls described herein. Similar to the embodiments described above, the user interface illustrated at 500 has a breakpoint bar 507 having multiple selectable breakpoints. The user interface illustrated at 500 further comprises a max-width toggle 508 which can be seen in the representation of the user interface at 502. For clarity, the max-width toggle 508 is shown in expanded form to the upper right region of the figure. In the current example, the max-width toggle 508 is located in the breakpoint bar adjacent the largest breakpoint relative to the central axis described above. However, the max-width toggle 508 may be located at other locations in the user interface.

In the illustrated and described embodiment, the max-width toggle 508 has two modes that may be selectable by a user, such as alternating between a first mode and a second mode when clicked, for example. In a first mode, the max-width toggle 508 may display a representation of arrows facing inwards, towards the breakpoints in the breakpoint bar. A page displayed in the design surface adjacent the breakpoint bar can be sized to the outer width 510 of the largest breakpoint, such as in the representation of the user interface at 502. The page can be resized using a scrubber and a select-and-drag input as described above, or by selecting the largest breakpoint, to name some examples.

The page is then resized beyond the outer width of the largest breakpoint, as shown in the representation of the user interface at 504. When this occurs and the max-width toggle 508 faces inwards, the content on the page maintains the width 510 of the largest breakpoint. Further, a border 512 on either side is added to the additional width that extends beyond the maximum width of the largest breakpoint. This allows the content to remain at the maximum designated width of the largest breakpoint as the page is resized beyond the maximum width. The border 512 will continue to be resized as the page continues to grow beyond the outermost width of the largest breakpoint, while the content remains the size of the largest breakpoint. This may be considered as the max-width toggle being “turned on.”

In a second mode, the max-width toggle 508 may display a representation of arrows facing outwards, away from the breakpoints in the breakpoint bar. For clarity, the max-width toggle 508 is shown in expanded form to the upper right region of the figure. When the page is resized beyond the outer width of the largest breakpoint, as shown in the representation of the user interface at 506, the content on the page continues to be resized proportionally with the growing width 514 of the page. This may also be considered as the max-width toggle being “turned off” In other words, there is no maximum width of the design surface and the content will continue to be resized as the design surface continues to grow beyond the outermost width of the largest breakpoint.

Having considered how a max-width toggle can control the behavior of content when a size of a page extends beyond a maximum width, consider now techniques for indicating and controlling how content on a page will behave when the page is resized to be smaller than a designated minimum width.

Minimum Width and Cropping Visual within Minimum Width

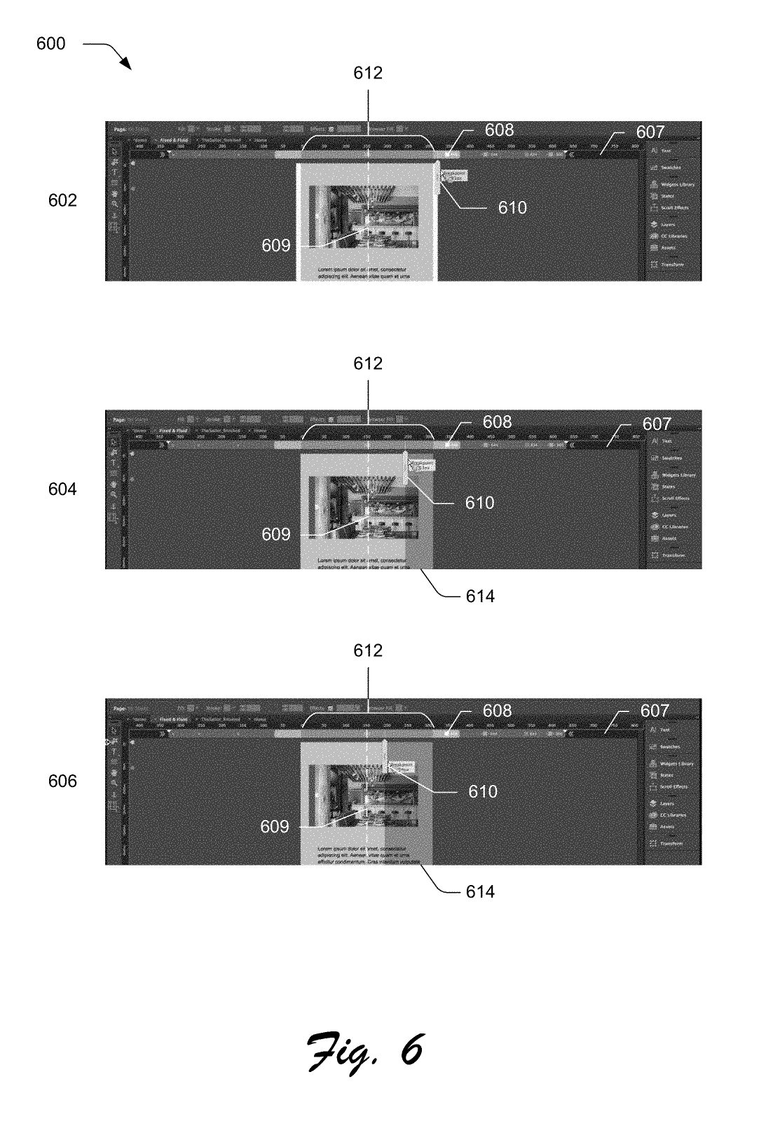

Turning now to FIG. 6, a user interface is illustrated generally at 600 and is configured to implement responsive design controls in accordance with one or more embodiments. The user interface illustrated in FIG. 6 may have any or all of the functionalities of responsive design controls described herein. Similar to the embodiments described above, the user interface illustrated at 600 has a breakpoint bar 607 having multiple selectable breakpoints. Further illustrated in the representation of the user interface 602 is a breakpoint 608, which is the smallest of the multiple selectable breakpoints in the breakpoint bar 607. Additionally, a central axis 609 is depicted, to give a visual representation of how content is aligned around the central axis 609 when the page is resized. The user interface may also comprise a scrubber 610, which is configured to resize content in the design surface.

The user interface may further have a minimum-width indicator 612, which overlays the smallest breakpoint 608 in the breakpoint bar. For instance, the minimum-width indicator 612 may provide a semi-transparent overlay of the smallest breakpoint 608, so that when the smallest breakpoint 608 is the active breakpoint, the minimum-width indicator does not obscure the active breakpoint color of the smallest breakpoint. The minimum-width indicator 612 represents a set width at which the content on the page does not resize any smaller, regardless of the width of the design surface or the width of a browser previewing the content.

For example, moving to the representation of the user interface 604, the scrubber 610 has moved to resize the page to be smaller than a designated minimum width represented by the minimum-width indicator 612. When this occurs, the visual of the page is “cropped” using an overlay 614. The overlay 614 represents content on the page that will not be immediately visible when a browser displaying the page is resized to be smaller than the minimum width, although the web browser may display horizontal scroll bar to allow the user to reach hidden content. This gives a user an idea of how the page will respond to resizing a browser to be smaller than the minimum width 612 while constructing and editing the user's design. For example, in one or more implementations, the user can see how the content remains aligned relative to the central axis 609 of the minimum width, rather than continuing to be resized according to a left-aligned artboard as discussed above.

The representation of the user interface at 606 illustrates the scrubber 610 continuing to move within the minimum width 612. As illustrated in the representation of the user interface at 606, the page does not resize beyond the minimum width 612 even as the scrubber continues to make the preview of the page smaller and smaller. Instead, the overlay 614 increases in size to cover the area that will be cropped when the page is resized accordingly in the browser. Again, this gives the user an idea of how the page will respond to resizing a browser to an even smaller size beyond the minimum width 612 while constructing and editing the user's design.

Having considered techniques for indicating and controlling how content on a page will behave when the page is resized to be smaller than a designated minimum width, consider now how mixing fixed and fluid breakpoints on a page can be used to control the behavior of content on a page when displayed at different sizes.

### Mixing Fixed and Fluid Breakpoints on a Page

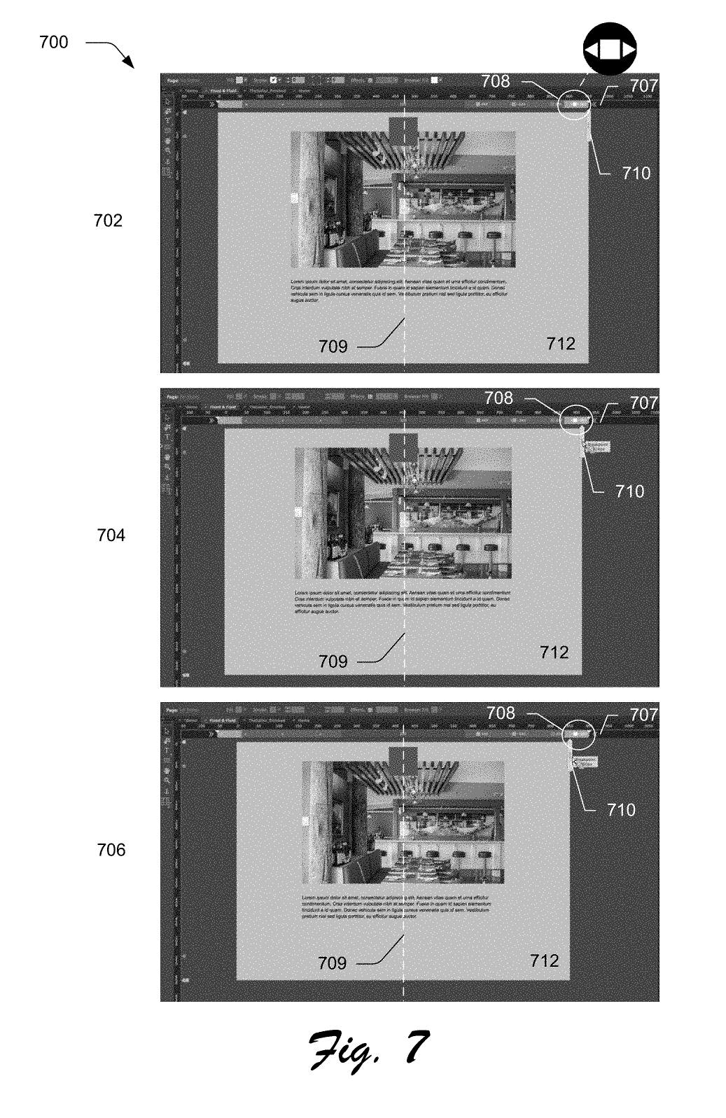

FIG. 7 illustrates a user interface, generally at 700, such as the user interface of FIG. 3, configured to implement responsive design controls in accordance with one or more embodiments. The user interface illustrated in FIG. 7 may have any or all of the functionalities of responsive design controls described herein. Similar to the embodiments described above, the user interface illustrated at 700 has a breakpoint bar 707 having multiple selectable breakpoints. Additionally, a central axis 709 is depicted, to give a visual representation of how content is aligned around the central axis 709 when the page is resized. In the representation of the user interface at 702, the largest breakpoint 708 is selected as the active breakpoint. The largest breakpoint 708 is designated as a fluid breakpoint. A fluid breakpoint causes items of content on a page to be resized proportionally as the page is resized within the breakpoint. The fluid breakpoint may be indicated by an icon within the breakpoint in the breakpoint bar. For clarity, the fluid breakpoint indicator is shown in expanded form to the upper right region of the figure.

To further illustrate, a scrubber 710 is selected and moved within a fluid breakpoint 708 to resize the page, as can be seen from the representation of the user interface at 702 to the representation of the user interface at 704. In the representation of the user interface at 702, when the scrubber 710 is closest to the maximum width of the active breakpoint 708, the items of content 712 are shown at a first size and location. In the representation of the user interface at 704, the scrubber 710 is moved slightly to make the page smaller within the same breakpoint 708. The items of content 712 are resized and adjusted proportionally to the amount the page has been resized. The items of content 712 may be resized and adjusted about the central axis 709, as discussed above.

The scrubber 710 is then selected and moved within the fluid breakpoint 708 to again resize the page, seen from the representation of the user interface at 704 to the representation of the user interface at 706. In the representation of the user interface at 706, the scrubber 710 is moved to make the page even smaller within the same breakpoint 708. The items of content 712 are again resized and adjusted proportionally to the amount the page has been resized. Similar to above, the items of content 712 may be resized and adjusted about the central axis 709.

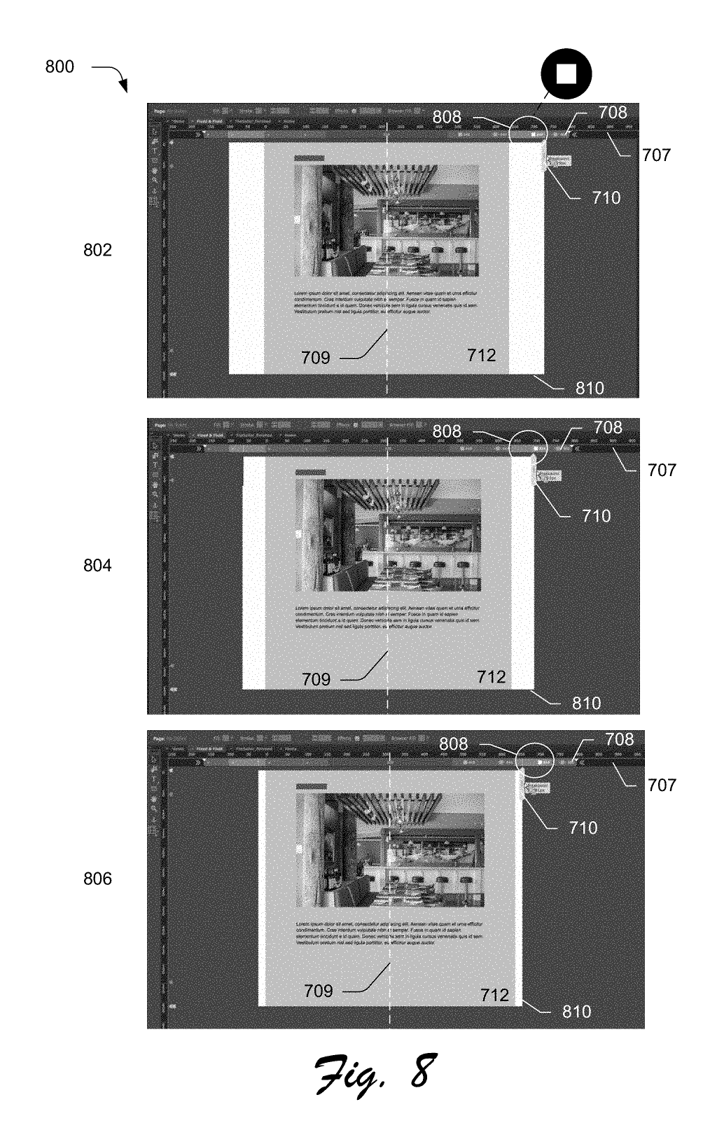

Turning now to FIG. 8, a user interface is illustrated, generally at 800, such as the user interface of FIG. 7. The user interface illustrated at 800 has the same breakpoint bar 707 as illustrated at 700 in FIG. 7, along with the central axis 709. For example, the breakpoint bar illustrated in user interface 800 contains the fluid breakpoint 708, and additionally contains a fixed breakpoint 808. A fixed breakpoint causes items of content on a page to remain a fixed size as the page is resized within the size range of the breakpoint. The fixed breakpoint may also be indicated by an icon within the breakpoint in the breakpoint bar. For clarity, the fixed breakpoint indicator is shown in expanded form to the upper right region of the figure.

To demonstrate, the scrubber 710 described in relation to FIG. 7 may be selected and moved from the fluid breakpoint 708 into the size range of the fixed breakpoint 808. At the defined size of the breakpoint 808, behavior of content 712 displayed on the design surface changes. In this case, the items of content 712 are no longer resized proportionally as the page is resized within the active breakpoint. Instead, the items of content 712 will remain the same size as the page is resized within the breakpoint 808. To accomplish this, a border region 810 is added, which is approximately the width of the breakpoint 808. The content 712 maintains a width approximately equal to the smallest width of the breakpoint 808, so that it will not be resized at any point within the breakpoint 808 as the page is resized within the breakpoint 808.

Again, the scrubber 710 is selected and moved within the fixed breakpoint 808 to resize the page, seen from the representation of the user interface at 802 to the representation of the user interface at 804. In the representation of the user interface at 804, the scrubber 710 is moved to make the page smaller within the same breakpoint 808. The items of content 712 remain the same size, but the border region 810 is resized according to the amount the page has been resized. In order to maintain continuity about the central axis 709, the border region 810 appears on either side of the content 712, and is resized on both sides of the content 712 as the page is resized in the breakpoint 808.

The scrubber 710 is selected once again and moved within the fixed breakpoint 808 to resize the page, seen from the representation of the user interface at 804 to the representation of the user interface at 806. The page is resized in the representation of the user interface at 806 to make the page even smaller within the same breakpoint 808. The items of content 712 remain the same size, but the border region 810 is again resized according to the amount the page has been resized. Similar to the description above, the border region 810 is resized on both sides of the content 712 respective to the central axis 709.

FIGS. 7 and 8 are representative of the ability to mix fluid and fixed breakpoints within a single page layout design. For example, when a page layout having both fixed and fluid breakpoints is published, a viewer may open the page in a web browser on their desktop computer. The page may be designated as having a fluid layout for a full-screen width of the browser on the particular device. As the viewer adjusts the size of the browser on the desktop computer within the size range associated with the fluid breakpoint, the content will be resized proportionally to the amount that the browser is resized. When the viewer adjusts the size of the browser to a size range of a fixed breakpoint, the page will adjust such that the content becomes a fixed size, and border regions are visible as described above. While only two breakpoints, one being fluid and one being fixed, are described in this section, it should be understood that any number of breakpoints may be considered, with combinations of both fixed and fluid breakpoints making up multiple breakpoints of the page.

Having considered mixing fixed and fluid breakpoints on a page to control the behavior of content on a page when displayed at different sizes, consider now a resize control for controlling how a particular item of content will behave when a page is resized.

Resize Control

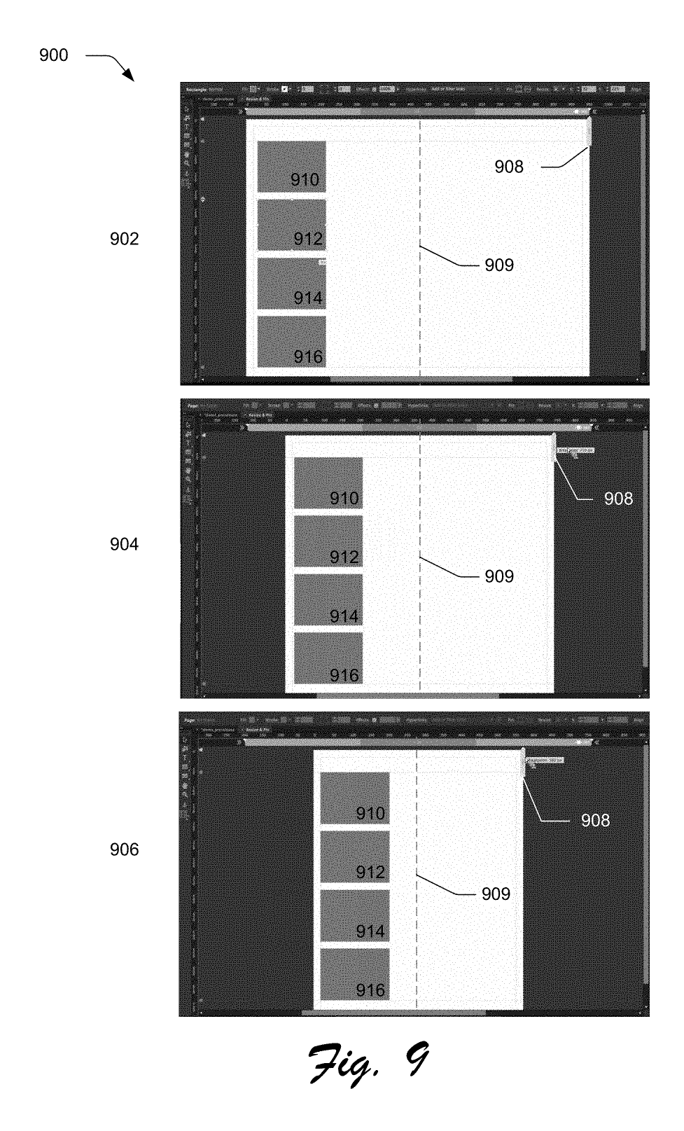

As discussed above, a control can be provided in the user interface with options for resizing a selected item of content in relation to a width of a page displayed in a design surface or browser window. In order to provide a basis of understanding for how the resize control operates, consider FIG. 9, which illustrates a user interface generally at 900. The user interface illustrated in FIG. 9 may have any or all of the functionalities of responsive design controls described herein.

In the representation of the user interface at 902, a scrubber 908 is illustrated at a location on a design surface. Additionally, four blocks 910-916 are shown on a page, where none of the four blocks 910-916 have any resizing characteristics applied. The scrubber 908 is selected and moved to resize the page in the design surface, represented from the user interface at 902 to the user interface at 904. As the scrubber 908 moves to resize the page, the blocks 910-916 remain the same size and in the same position.

Next, the scrubber 908 is selected and moved to resize the page in the design surface, represented from the user interface at 904 to the user interface at 906. As the scrubber 908 moves to further resize the page, the blocks 910-916 again remain the same size and in the same position. Even though the blocks 910-916 appear generally on the left side of the page, the content of the page is still aligned relative to a central axis 909. Therefore, as the page is resized using the scrubber 908 on the right side of the page, both sides of the page are resized equally relative to the central axis 909.

Having considered items of content without any resizing effects applied, consider now how similar items of content are affected when resizing effects are applied as a page is resized.

Responsive Width

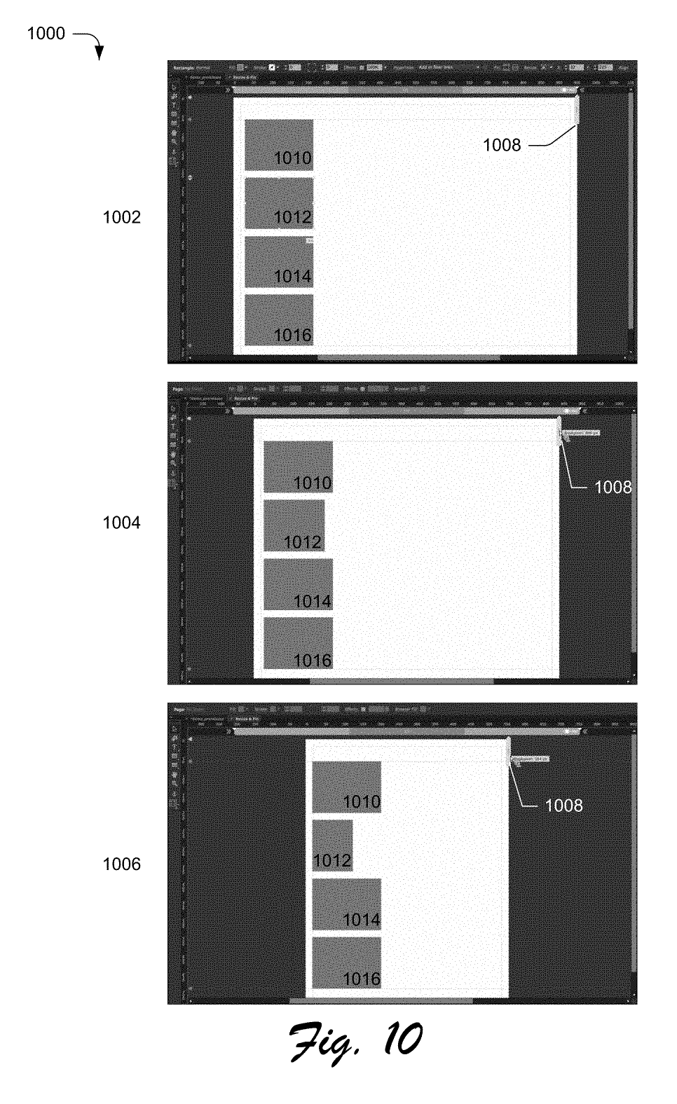

Turning now to FIG. 10, a user interface is illustrated generally at 1000. In the representation of the user interface at 1002, a user may select one of the blocks, such as block 1012. When block 1012 is selected, the user may choose to apply a “Responsive Width” characteristic to block 1012, such as by a menu selection or an icon in the user interface, for example. Responsive Width, when applied to an item of content, causes the width of the item of content to resize proportionally as the page is resized in the design surface or in a browser. In this case, blocks 1010, 1014, and 1016 have no resize settings applied. For example, if the block 1012 appears in a fluid breakpoint where content resizes as the page is resized, block 1012 will resize proportionally in width with the page. For purposes of comparison, blocks 1010, 1014, and 1016 remain the same size as the page is resized in FIG. 10, while block 1012 demonstrates the Responsive Width characteristic. Alternatively or additionally, the blocks 1010, 1014, and 1016 may have a Responsive Width default setting applied when no other selections have been made.

To illustrate, the scrubber 1008 is selected and moved to resize the page from the representation of the user interface at 1002 to the representation of the user interface at 1004. The block 1012, with the Responsive Width characteristic applied, resizes proportionally in width with the resizing of the page. However, blocks 1010, 1014, and 1016 remain the same size and in the same position, similar to the discussion of the blocks in FIG. 9. As the scrubber 1008 is selected and moved further in the representation of the user interface at 1006, the block 1012 continues to resize proportionally in width with the page, while blocks 1010, 1014, and 1016 remain the same size and in the same position.

### Responsive Width and Height

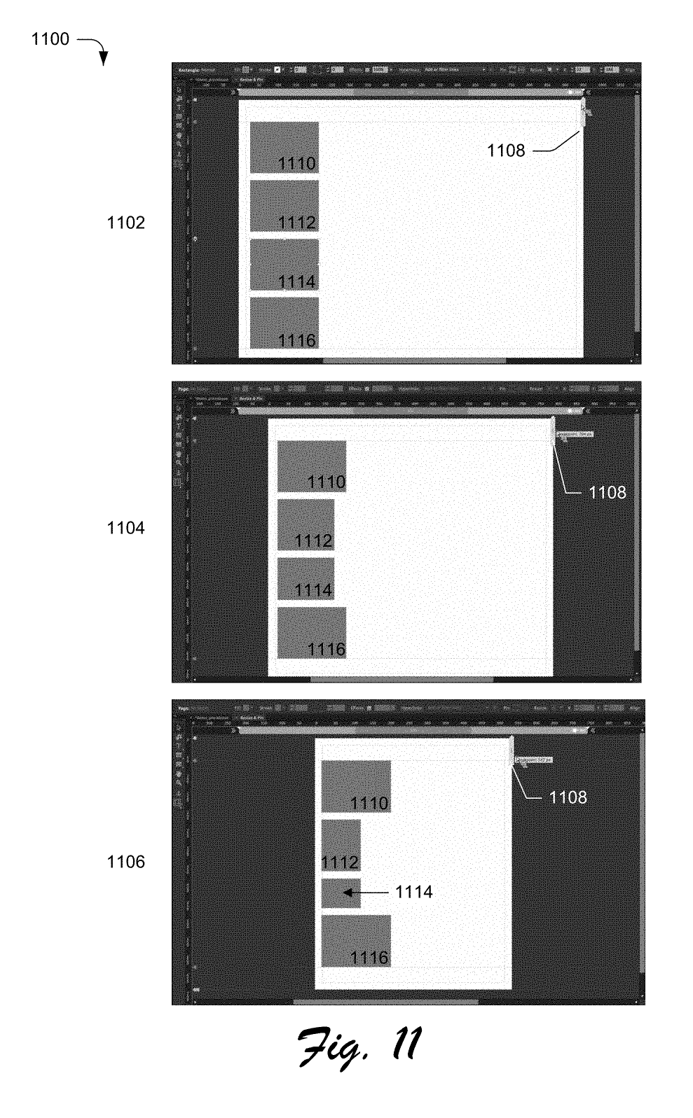

FIG. 11 illustrates a user interface generally at 1100 in accordance with one or more embodiments. In the representation of the user interface at 1102, a user may select one of the blocks, such as block 1114. When block 1114 is selected, the user may choose to apply a “Responsive Width and Height” characteristic to the block 1114, such as by a menu selection or an icon in the user interface, for example. Responsive Width and Height, when applied to an item of content, causes the item of content to resize proportionally in both width and height as the page is resized in the design surface or in a browser. In this case, blocks 1110 and 1116 have no resize settings applied. For instance, if the block 1114 appears in a fluid breakpoint where content resizes as the page is resized, block 1114 will resize proportionally in both width and height with the page. In other words, the block 1114 will keep the same ratio of dimensions in width and height as the page is resized, as opposed to only the width changing as the page is resized if the Responsive Width characteristic was selected. While blocks 1110 and 1116 remain the same size for purposes of comparison in FIG. 11, blocks 1110 and 1116 may behave according to the default fluid width setting described above.

To demonstrate, the scrubber 1108 is selected and moved to resize the page from the representation of the user interface at 1102 to the representation of the user interface at 1104. The block 1114, with the Responsive Width and Height characteristic applied, resizes proportionally in both width and height with the resizing of the page. Blocks 1110 and 1116 remain the same size and in the same position, similar to the discussion of the blocks in FIG. 9. Further, block 1112 has the Responsive Width characteristic applied, which causes block 1112 to behave similarly to block 1012 of FIG. 10. The width of blocks 1112 and 1114 are both changing proportionally to the changing size of the page. However, block 1114 is also changing in height, keeping the same size ratio of width and height as the size of the page changes.

As the scrubber 1108 is selected and moved further in the representation of the user interface at 1106, the block 1112 continues to resize proportionally in width with the page. Further, block 1114 continues to resize proportionally in width and height, keeping the same size ratio of width and height as the size of the page changes. Blocks 1110 and 1116 remain the same size and in the same position on the page as the page is resized.

### Stretch to Browser Width

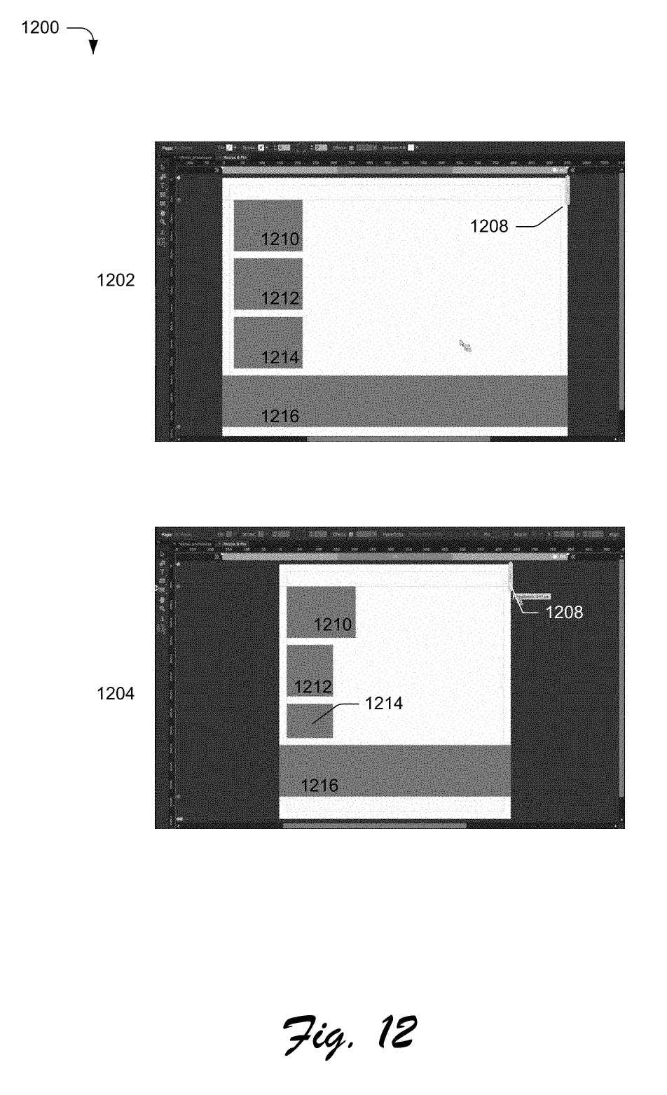

Turning next to FIG. 12, a user interface is illustrated generally at 1200. In the representation of the user interface at 1202, a user may select one of the blocks, and may choose to apply a “Stretch to Browser Width” characteristic to the block, such as by a menu selection or an icon in the user interface, for example. In the representation of the user interface at 1202, block 1216 has been selected and the Stretch to Browser Width characteristic has been applied. The Stretch to Browser Width characteristic causes the selected block to extend to the width of the page in the design surface or a browser window, regardless of the width of the design surface or browser window. Additionally, the Stretch to Browser Width characteristic operates the same regardless of the type of breakpoint: fixed or fluid.

To illustrate, the scrubber 1208 is selected and moved to resize the page from the representation of the user interface at 1202 to the representation of the user interface at 1204. The block 1216, with the Stretch to Browser Window characteristic applied, automatically resizes to extend to the width of the page as the page is resized. Block 1210 remains the same size and in the same position, similar to the discussion of the blocks in FIG. 9. Block 1212 has the Responsive Width characteristic applied, which causes block 1212 to behave similarly to block 1012 of FIG. 10. Block 1214 has the Responsive Width and Height characteristic applied, which causes block 1214 to behave similarly to block 1114 of FIG. 11. The width of blocks 1112 and 1114 are both changing proportionally to the changing size of the page. Block 1114 is also changing in height, keeping the same size ratio of width and height as the size of the page changes. Block 1216 maintains the same height as the size of the page changes, but maintains the same width of the page as the page is resized.

While the examples provided above relate to the behaviors of content items in a single breakpoint, these techniques may be employed with multiple breakpoints on a single page together with additional techniques described herein. In but one example, an item of content may have a Responsive Width characteristic applied in one breakpoint of multiple breakpoints on a page. The same item of content may have a Responsive Width and Height characteristic applied on a second breakpoint on the same page. The same item of content may then have a Stretch to Browser Window characteristic applied on a third breakpoint on the same page, and no resizing characteristic applied to the same item of content on a fourth breakpoint on the same page. Any number of combinations of resizing controls may be applied to items of content in any number of breakpoints without departing from the scope of the claimed subject matter.

Having considered options for resizing items of content when a page is resized, consider now how items of content are affected with a pinning control applied when a page is resized.

### Pinning Controls

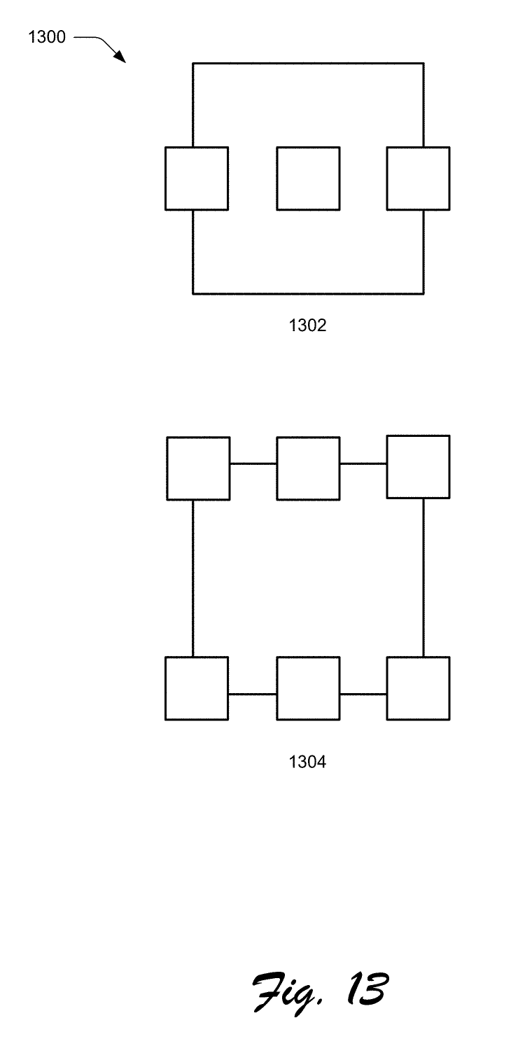

As discussed above, the techniques described herein provide pinning controls for pinning items of content relative to a page, and pinning items of content relative to a browser window that displays the page. These pinning controls may be implemented as icons in the user interface that are present and selectable when one or more items of content are selected. For instance, consider FIG. 13, which illustrates two examples of pinning controls at 1300 which may appear in a user interface for implementing responsive design controls. The pinning controls described in relation to FIGS. 13-18 may be used with any or all of the functionalities of responsive design controls described herein.

A first pinning control 1302 may be used to pin one or more items of content relative to the page on which the item of content is displayed. This first pinning control 1302 is illustrated as having three selectable icons that generally span a horizontal central axis of the pinning control; a left icon, a center icon, and a right icon. A second pinning control 1304 may be used to pin one or more items of content relative to a browser window in which the page containing the content is displayed. The second pinning control 1304 is illustrated as having six selectable icons, three of which span a top horizontal axis of the pinning control and three of which span a bottom horizontal axis of the pinning control. The second pinning control 1304 thus comprises a top left icon, a top middle icon, a top right icon, a bottom left icon, a bottom middle icon, and a bottom left icon. Functionality associated with these pinning controls 1302 and 1304 is discussed in detail below. These pinning controls are intended only as examples of possibilities to implement the pinning functionality discussed below. Other embodiments of techniques to assign pinning functionality to items of content are also considered, such as drop-down menus, multi-input gestures, or modal windows, to name a few examples.

### Pinning Relative to Page

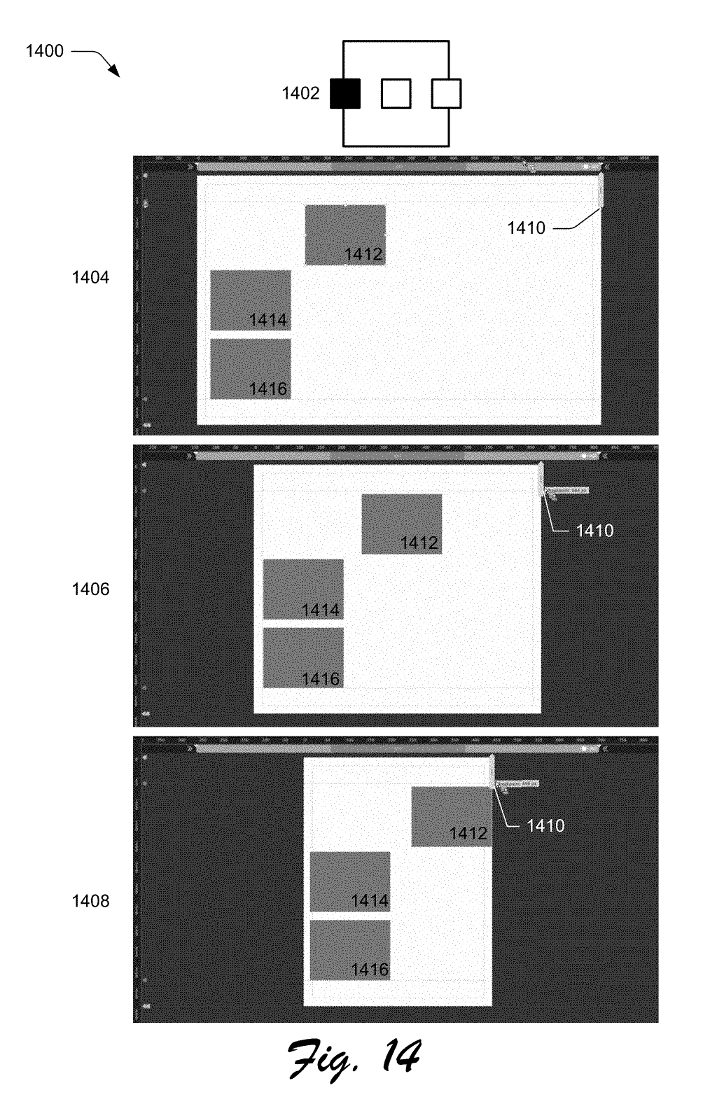

FIG. 14 illustrates a user interface, generally at 1400, such as the user interface of FIG. 3 and/or FIG. 9, configured to implement responsive design controls in accordance with one or more embodiments. FIG. 14 also illustrates a pinning control 1402. Though not pictured as such for clarity, the pinning control 1402 may be located in the user interface illustrated at 1400, such as in a toolbar. The pinning control 1402 is configured to pin one or more items of content relative to the page on which the item of content is displayed. In this example, a user has selected a left icon of the pinning control 1402 to apply to a block 1412 of content in a first representation of the user interface 1404. Selection of the left icon in the pinning control 1402 will cause the block 1412 to maintain a set distance from the left side of the page when the page is resized in the design surface or in a browser window.

For example, a scrubber 1410 is selected and moved from a first position in the representation of the user interface at 1404 to a second position in the representation of the user interface at 1406. Because the block 1412 is pinned relative to the left side of the page, the block 1412 will keep the same distance from the left side of the page as the page is resized in the design surface. Therefore, the distance from the block 1412 to the right side of the page will decrease the same amount as the page size is decreased, rather than decreasing proportionally on both the left and right side of the block 1412. The scrubber 1410 is then selected and moved from the second position in the representation of the user interface at 1406 to a third position in the representation of the user interface at 1408. There is no longer any distance between the block 1412 and the right side of the page, however the same distance remains between the block 1412 and the left side of the page.

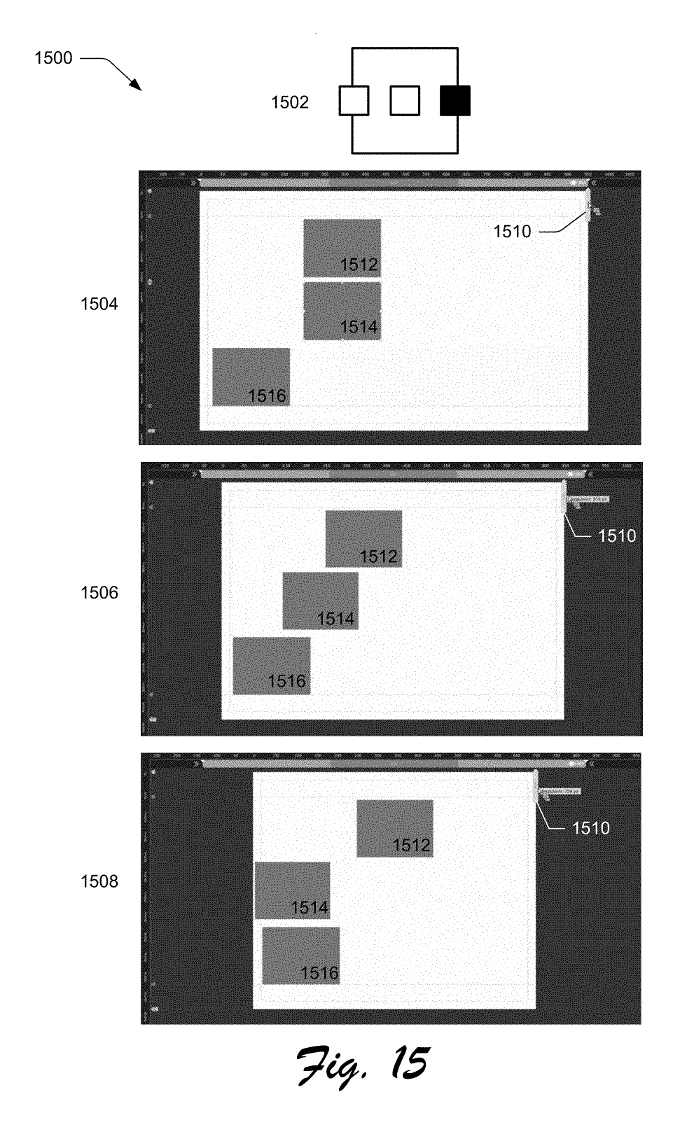

Turning to FIG. 15, a user interface is illustrated generally at 1500, which may be similar to the user interface of FIG. 14. FIG. 15 also illustrates a pinning control 1502, such as the pinning control 1302 of FIG. 13. Though not pictured as such for clarity, the pinning control 1502 may be located in the user interface illustrated at 1500, such as in a toolbar. The pinning control 1502 is configured to pin one or more items of content relative to the page on which the item of content is displayed. In this instance, a user has selected a right icon of the pinning control 1502 to apply to a block 1514 of content in a first representation of the user interface 1504. Selection of the right icon in the pinning control 1502 will cause the block 1514 to maintain a set distance from the right side of the page when the page is resized in the design surface or in a browser window. For a comparison of behaviors, blocks 1512 and 1516 are also pictured, and a user has pinned blocks 1512 and 1516 to the left side of the page, similar to block 1412 of FIG. 14.

In this example, a scrubber 1510 is selected and moved from a first position in the representation of the user interface at 1504 to a second position in the representation of the user interface at 1506. Because the block 1514 is pinned relative to the right side of the page, the block 1514 will keep the same distance from the right side of the page as the page is resized in the design surface. The distance between block 1514 and the left side of the page will decrease the same amount as the page size is decreased, rather than decreasing proportionally on both the left and right side of the block 1514. Additionally, similar to the discussion above, blocks 1512 and 1516 will keep the same distance from the left side of the page as the page is resized in the design surface because blocks 1512 and 1516 are pinned to the left side of the page.

The scrubber 1510 is then selected and moved from the second position in the representation of the user interface at 1506 to a third position in the representation of the user interface at 1508. Even as the page becomes smaller, the distance between the block 1514 and the right side of the page remains constant. Though not pictured, resizing the page to a size smaller than pictured in the representation of the user interface at 1508 may cause the block to be repositioned outside of the viewable page bound in order to maintain the distance set when the block 1514 is pinned. Further, blocks 1512 and 1516 maintain the same distance from the left side of the page as the page is resized in the design surface, while the distance between the blocks 1512 and 1516 and the right side of the design surface decreases with the size of the page.

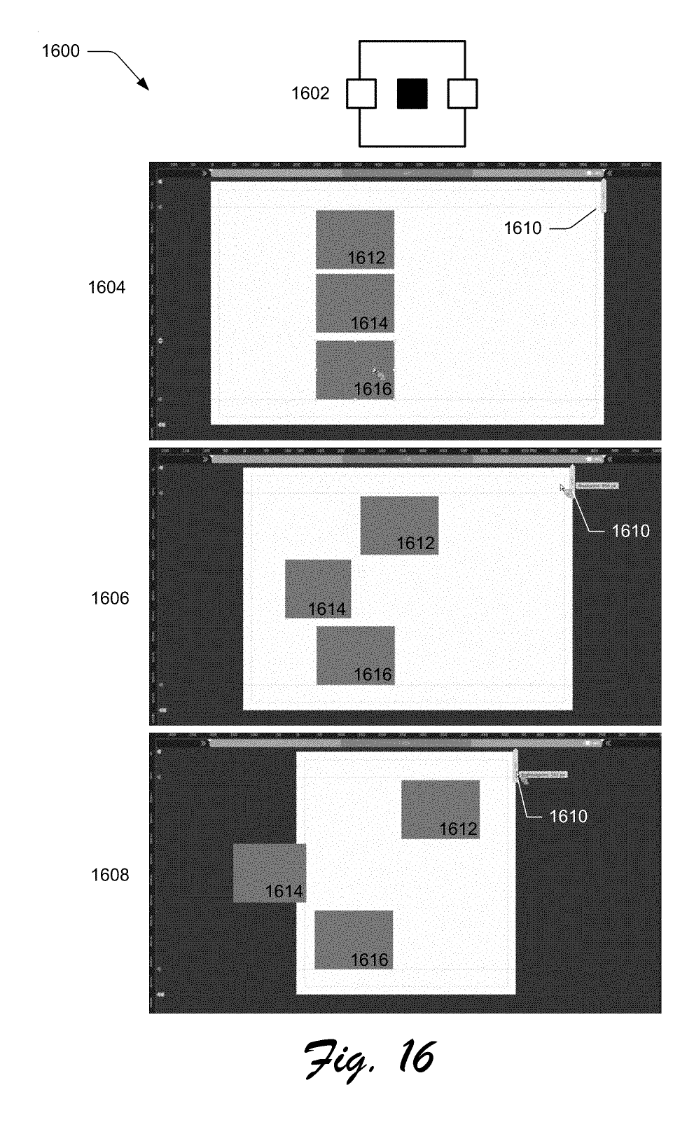

Now turning to FIG. 16, a user interface is illustrated generally at 1600, which may be similar to the user interfaces of FIGS. 14 and 15. FIG. 16 also illustrates a pinning control 1602, such as the pinning control 1302 of FIG. 13. Though not pictured as such for clarity, the pinning control 1602 may be located in the user interface illustrated at 1600, such as in a toolbar. The pinning control 1602 is configured to pin one or more items of content relative to the page on which the item of content is displayed. In this instance, a user has selected a center icon of the pinning control 1602 to apply to a block 1616 of content in a first representation of the user interface 1604. Selection of the center icon in the pinning control 1602 will cause the center of block 1616 to maintain a set distance from the center of the page when the page is resized in the design surface or in a browser window. For a comparison of behaviors, blocks 1612 and 1614 are also pictured. A user has pinned block 1612 to the left side of the page, similar to block 1412 of FIG. 14. The user has also pinned block 1614 to the right side of the page, similar to block 1514 of FIG. 15.

In this example, a scrubber 1610 is selected and moved from a first position in the representation of the user interface at 1604 to a second position in the representation of the user interface at 1606. Because the block 1616 is pinned relative to the center of the page, the center of block 1616 will keep the same distance from the center of the page as the page is resized in the design surface. In this case, the distances between block 1616 and both the left side of the page and the right side of the page will decrease an amount that will maintain the distance between the center of block 1616 and the center of the page. Additionally, similar to the discussion above, block 1612 will keep the same distance from the left side of the page as the page is resized in the design surface because block 1612 is pinned to the left side of the page. Further, block 1614 will keep the same distance from the right side of the page as the page is resized in the design surface because block 1614 is pinned to the right side of the page.

The scrubber 1610 is then selected and moved from the second position in the representation of the user interface at 1606 to a third position in the representation of the user interface at 1608. Even as the page becomes smaller, the distance between the center of block 1616 and the center of the page remains constant. Also illustrated in the representation of the user interface at 1608 is the result of resizing the page to a size that results in the block 1614 to be repositioned outside of the viewable page bound in order to maintain the distance set when the block 1614 was pinned. Should the page reach a small enough size, the block 1616 may have a similar result in order to maintain the distance between the center of block 1616 and the center of the page. In other words, the block 1616 may be repositioned outside of the viewable page bound in order to maintain the distance set from the center of the page when the block 1616 was pinned. Further, block 1612 maintains the same distance from the left side of the page as the page is resized in the design surface, while the distance between the block 1612 and the right side of the design surface decreases with the size of the page.

It should be noted that pinning content items relative to the page has no effect on the size of the content items as the size of the page changes. As can be seen in the representations of the user interface from 1604 to 1608, only the position of the blocks 1612, 1614, and 1616 change as the page is resized. However, pinning content items relative to the page can readily be combined with the resizing techniques described above, giving designers countless options for content behavior that were not previously available with previous techniques. Further, while the examples provided above relate to the behaviors of content items in a single breakpoint, one skilled in the art will appreciate that these techniques may be employed with multiple breakpoints on a single page together with additional techniques described herein.

In addition, any combination of the locations relative to the page described in relation to FIGS. 14-16 may be used together to pin items of content. In but one example, a user may pin an item of content having a width of 500 pixels relative to both the left and right of the page. In this example, the page may be 1000 pixels in width, and the item of content is pinned 100 pixels from the left side of the page and 400 pixels from the right side of the page. If the page is resized to be 1100 pixels in width, the item of content will resize to be 600 pixels in width, while maintaining the 100 pixels from the left side of the page and the 400 pixels from the right side of the page. Pinning to the left and right of the page presents different functionality than pinning the item of content to the left while the item of content has a Responsive Width characteristic applied, for example. When the item of content having the same dimensions and location on the page is pinned to the left of the page with the Responsive Width characteristic applied, the item of content will resize to be 550 pixels when the page is resized to 1100 pixels in width. Other combinations of pinning relative to locations of a page are contemplated, such as pinning to the left side of the page and the center of the page, and pinning to the center of the page and the right of the page, to name a few examples.

Pinning Relative to Browser Window

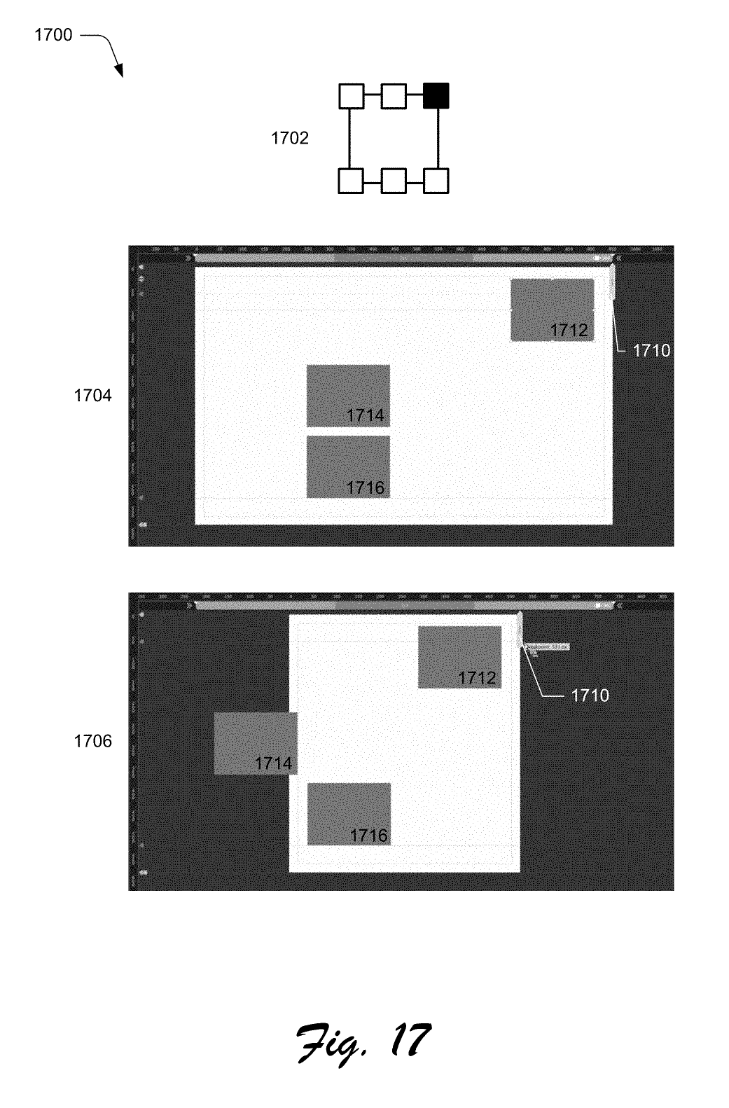

FIG. 17 illustrates a user interface, generally at 1700, such as the user interface of FIG. 3 and/or FIG. 9, configured to implement responsive design controls in accordance with one or more embodiments. FIG. 17 also illustrates a pinning control 1702, such as the pinning control 1304 of FIG. 13. Though not pictured as such for clarity, the pinning control 1702 may be located in the user interface illustrated at 1700, such as in a toolbar. The pinning control 1702 is configured to pin one or more items of content relative to a browser window in which the item of content is displayed. In this example, a user has selected a top-right icon of the pinning control 1702 to apply to a block 1712 of content in a first representation of the user interface 1704. Selection of the top-right icon in the pinning control 1702 will cause the block 1712 to maintain a set distance from the top, right corner of a browser window that displays a page containing the item of content. The set distance will be maintained relative to the browser window both when the page is resized in the design surface or in the browser window, and as the page is scrolled in the browser window.

For example, a scrubber 1710 is selected and moved from a first position in the representation of the user interface at 1704 to a second position in the representation of the user interface at 1706. Because the block 1712 is pinned to the top-right corner using the pinning control 1702, the block 1712 maintains the same distance from the right side of the page in the design surface as the page is resized. Further, the distance from the block 1712 to the left side of the page decreases as the size of the page decreases. While previewing the page in the user interface at 1700, the block 1712 behaves similarly to the description of being pinned relative to the page as discussed above. In other words, block 1712 will scroll out of view when the design surface is scrolled. Alternatively or additionally, the design surface may behave exactly as the web browser and cause block 1712 to behave as discussed below.

However, when a page containing block 1712 is viewed in a browser, the block 1712 exhibits additional functionality as a result of being pinned relative to the browser window.

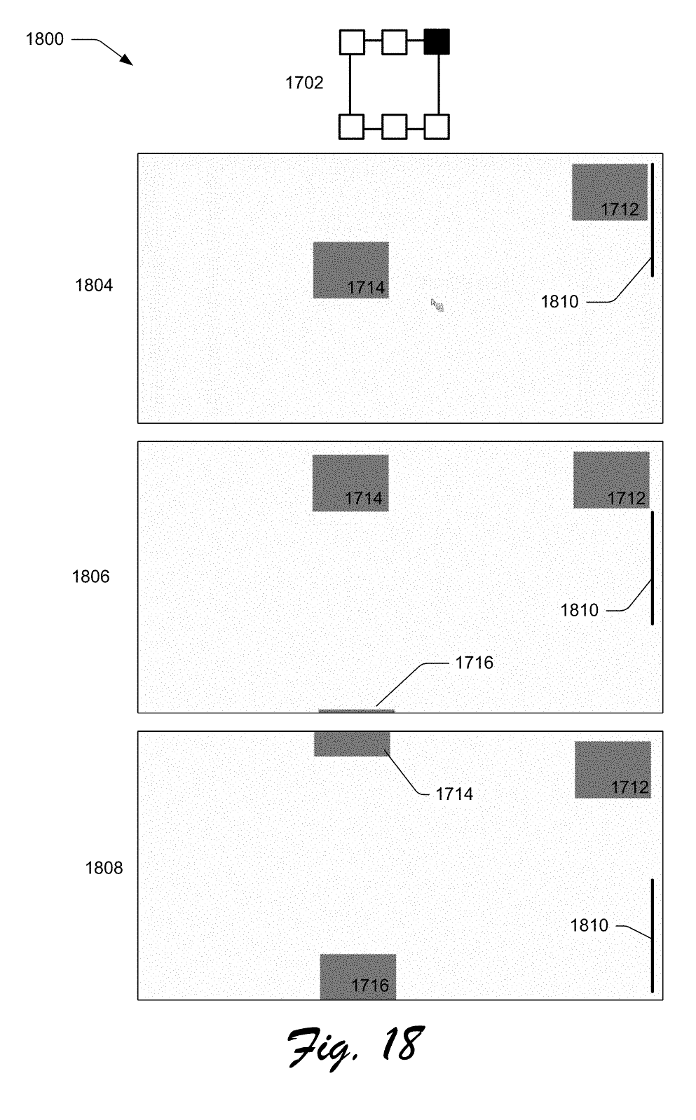

FIG. 18 illustrates a browser window, generally at 1800, which may be implemented as part of a browser, configured to display pages of content that have responsive design controls. Further, FIG. 18 illustrates the pinning control 1702, with the top-right icon selected to pin block 1712 relative to the browser window.

In the representation of the browser window at 1804, a scroll bar 1810 is illustrated indicating the browser window is located at the top of the page. The block 1712 is pinned to the top-right corner of the browser window, and is thus located in the top-right corner of the browser window in the representation of the browser window at 1804. Also pictured in the representation of the browser window at 1804 is block 1714, which has not been pinned relative to the browser window. Not visible in the representation of the browser window at 1804 is block 1716 which lies out of view. Block 1716 lies at a location on the page which is not currently visible in the browser window, because the browser window illustrated at 1800 is smaller than the page containing the blocks 1712-1716. Block 1716 also has not been pinned relative to the browser window.

The scroll bar 1810 moves from a first position in the representation of the user interface at 1804 to a second position in the representation of the user interface at 1806 to scroll the page down. Moving the scroll bar 1810 to scroll the page may be performed in any suitable way, such as a select-and-drag input, clicking an arrow associated with the scroll bar, using a scroll input on a mouse, or a coordinating touch gesture, to name some examples. As the page scrolls to the representation of the browser window at 1806, block 1714 moves accordingly with the page. Block 1716 also begins to become visible at the bottom of the page as the page scrolls. However, block 1712 maintains the same position in the browser window as the page scrolls. In other words, block 1712 does not move with the content of the page as the page scrolls, keeping the same distance from the top, right corner of the browser window. In another scenario, if the page is wider than the browser window, then a top-right browser pinned element such as block 1712 will maintain its location relative to the browser also when page is scrolled horizontally.

The scroll bar 1810 then moves from the second position in the representation of the user interface at 1806 to a third position in the representation of the user interface at 1808. As the page scrolls to the representation of the browser window at 1808, blocks 1714 and 1716 move accordingly with the page. However, block 1712 maintains the same position in the browser window as the page scrolls. Block 1712 continues to keep same distance from the top, right corner of the browser window, and does not move with the content of the page as the page scrolls.

While only one example of pinning an item of content relative to the browser window is provided, it is easily appreciated how items of content will behave when pinned to one of the other five icons in the pinning control 1304 for pinning content relative to the browser window. In one additional example, selecting the top-center icon to apply to an item of content will cause the item of content to maintain the same distance from the top and center of the browser window as the browser window is resized or scrolled. In yet another example, selecting the bottom-left icon to apply to an item of content will cause the item of content to maintain the same distance from the bottom and left side of the browser window as the browser window is resized or scrolled.

It should also be noted that pinning content items relative to the browser window has no effect on the size of the content items as the size of the browser window or design surface changes, or as the browser window is scrolled. As can be seen in the representations of the browser window from 1804 to 1808, only the position of the blocks 1714 and 1716 change as the page is scrolled. Similarly, as can be seen in the representations of the user interface from 1704 to 1706, only the position of the blocks 1712, 1714, and 1716 change as the page is resized. However, pinning content items relative to the browser window can readily be combined with the resizing techniques described above. Additionally, pinning content items relative to the browser window may also be combined with pinning other content items on the same page relative to the page. These combinations giving designers countless options for content behavior that were not previously available with previous techniques. Further, while the examples provided above relate to the behaviors of content items in a single breakpoint, one skilled in the art will appreciate that these techniques may be employed with multiple breakpoints on a single page together with additional techniques described herein.

Having considered options for pinning items of content when a page is resized, consider now controls for efficiently applying formatting changes across multiple breakpoints.

Formatting Control

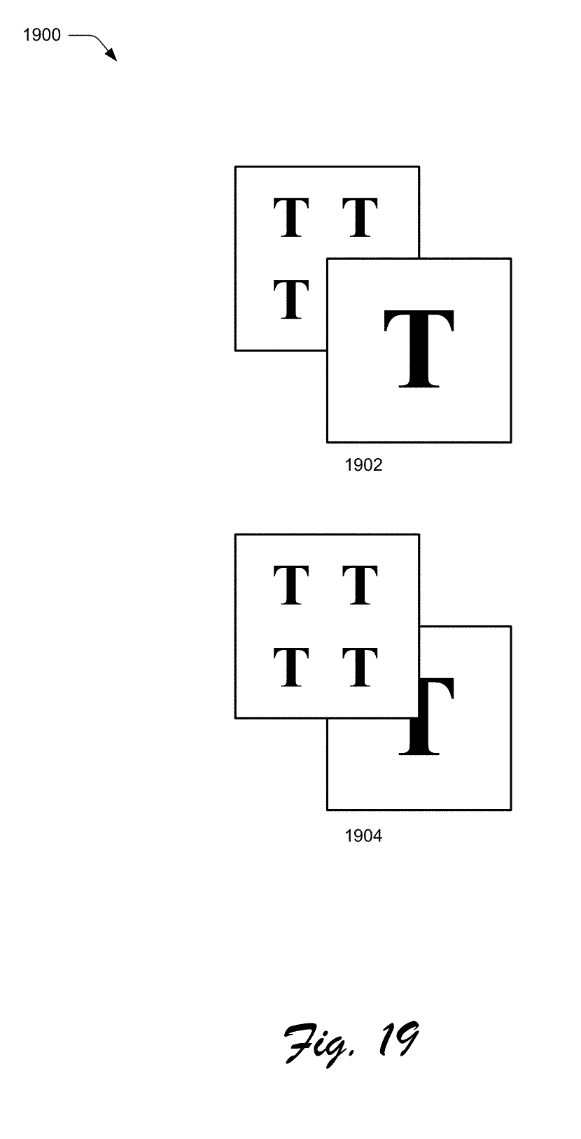

Techniques described herein further provide a formatting control for applying characteristics or properties to an item of digital content either only within the current breakpoint, or across more than one breakpoint. The formatting control may be implemented as a toggle in the user interface that is present and selectable when one or more items of content are selected. For instance, consider FIG. 19, which illustrates an example of a toggle at 1900 which may appear in a user interface for implementing responsive design controls. The formatting controls described in relation to FIGS. 19-21 may be used with any or all of the functionalities of responsive design controls described herein.

A first mode of the toggle is illustrated at 1902. This first mode 1902 has an icon with a single character, in this case a “T”, which is in the forefront of the toggle, and a second icon with multiple characters in the background of the toggle. In this first mode 1902 of the toggle, a characteristic or property applied to an item of content will only be applied to that item of content in the current breakpoint. In this example, the single “T” character corresponds to applying the characteristic or property only in a single breakpoint, the current breakpoint.

Following with the same example, a second mode of the toggle is illustrated at 1904. This second mode 1904 of the toggle has an icon with multiple characters, in this case four “T” characters, in the forefront of the toggle, and the icon with the single character in the background of the toggle. In this second mode 1904 of the toggle, a characteristic or property applied to an item of content will be applied to the item of content as the item of content appears in multiple breakpoints. For instance, the characteristic or property will be applied to the item of content in every breakpoint of the page. In this example, the multiple “T” characters correspond to applying the characteristic or property in multiple additional breakpoints along with the current breakpoint.

Functionality associated with the formatting control illustrated at 1900 is discussed in detail below. The particular formatting control described above is intended only as an example of a possibility to implement the formatting functionality discussed below. Other embodiments of techniques to selectively apply the formatting functionality to items of content are also considered, such as drop-down menus, multi-input gestures, or modal windows, to name a few examples.

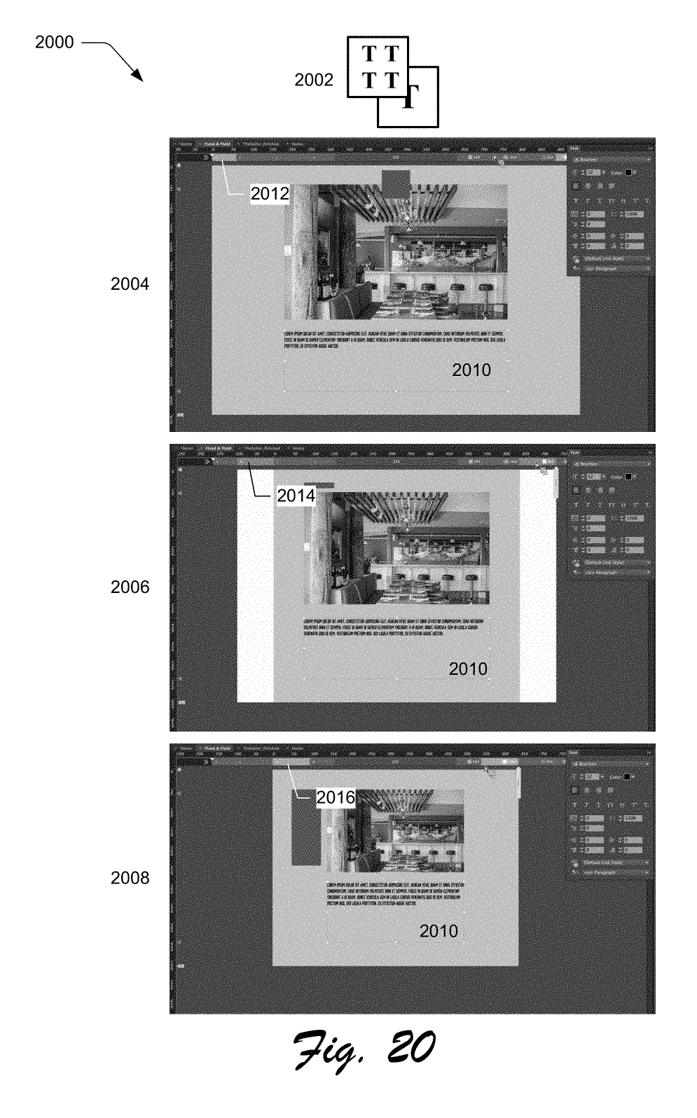

FIG. 20 illustrates a user interface, generally at 2000, such as the user interface of FIG. 3, configured to implement responsive design controls in accordance with one or more embodiments. FIG. 20 also illustrates a formatting control 2002, such as the formatting control shown at 1900 of FIG. 19. Though not pictured as such for clarity, the formatting control 2002 may be located in the user interface illustrated at 2000, such as in a toolbar. The formatting control 2002 is configured to apply characteristics or properties to an item of digital content either only within the current breakpoint, or across more than one breakpoint. In this example, a user has selected a mode of the toggle that will apply a characteristic or property across multiple breakpoints to an item of content, as described in relation to mode 1904 of FIG. 19.

For example, in the representation of the user interface at 2004, a user may select an item of content such as the text box 2010 in the current active breakpoint 2012. Next, the user may select the mode of the toggle 2002 which will cause a subsequently applied characteristic or property to the same text box 2010 across multiple breakpoints. The user may then apply a particular font as a characteristic to the text in the text box 2010. Because the particular mode of the toggle 2002 was selected, the font will be applied to the same text box in all of the multiple breakpoints of the page.

To illustrate, the breakpoint 2014 is selected in the representation of the user interface at 2006. Without further input from the user, the font has been automatically applied to the text in the text box 2010 in the breakpoint 2014. Likewise, selecting the breakpoint 2016 in the representation of the user interface 2008 displays the text in the text box 2010 with the font applied, without any further input from the user. Simply selecting the mode of the toggle before applying the font characteristic will apply the font across multiple breakpoints, without the user having to apply the font individually to the same text box in each breakpoint.

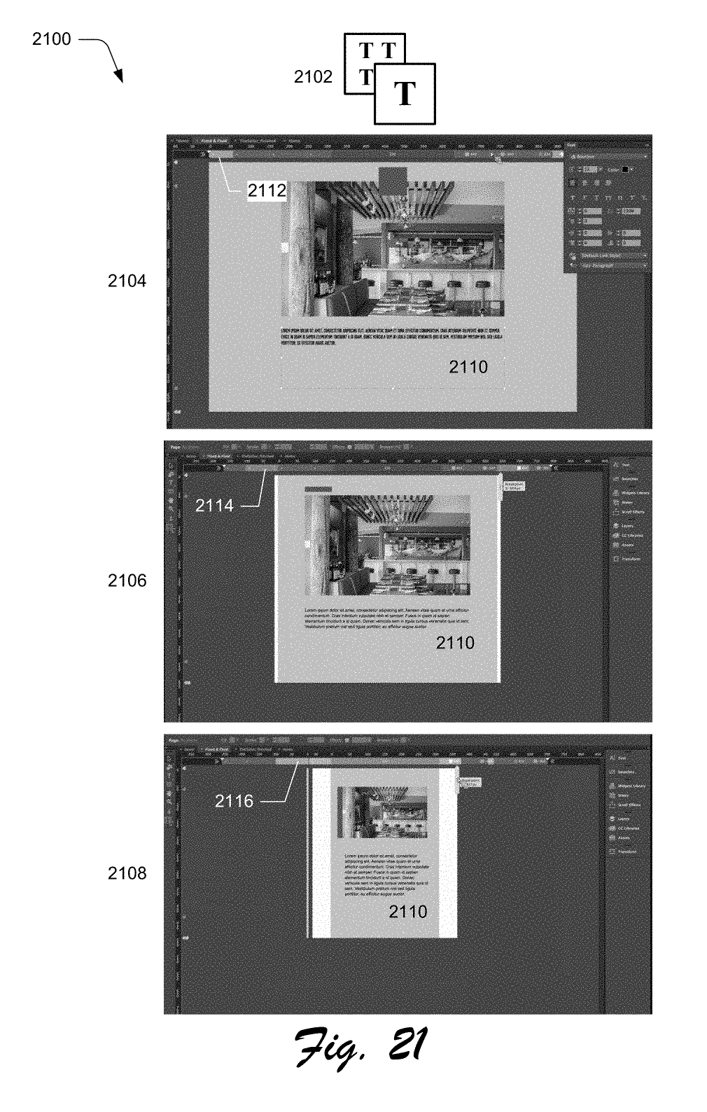

Turning to FIG. 21, a user interface is illustrated generally at 2100 that is configured to implement responsive design controls in accordance with one or more embodiments, such as the user interface of FIG. 3. FIG. 21 further illustrates a formatting control 2102, such as the formatting control shown at 1900 of FIG. 19. Though not pictured as such for clarity, the formatting control 2102 may be located in the user interface illustrated at 2100, such as in a toolbar. The formatting control 2102 is configured to apply characteristics or properties to an item of digital content either only within the current breakpoint, or across more than one breakpoint. In this example, a user has selected a mode of the toggle that will apply a characteristic or property only to the item of content in the current, active breakpoint rather than across multiple breakpoints.

For example, a user may have applied a font to an item of content such as the text box 2110 in the current active breakpoint 2112. Consider an example where a user wishes to only have the font applied to the breakpoint 2112, and have another font for the text in the text box 2110 rest of the breakpoints. In this case, while the user has selected the text in the text box 2110, the user then selects the alternate mode of the toggle 2102 to cause any subsequently applied characteristics to be applied only the current breakpoint. The user then changes the font of the text in the text box 2110. This will cause the font to be applied only to the text box 2110 in the current, active breakpoint, and the text in the text box 2110 in the other breakpoints will remain the same without any change.

To illustrate this concept, the breakpoint 2114 is selected in the representation of the user interface at 2106, where the font of the text in the text box 2110 is not the same as in the breakpoint 2112. The representation of the user interface at 2108 also shows that the font of the text in the text box 2110 in the breakpoint 2116 is not the same font as in the breakpoint 2112. The font of the text in the text box 2110 displayed in the breakpoints 2114 and 2116 remains the same when the font of the text in the text box 2110 appearing in the breakpoint 2112 changes. The formatting toggle therefore provides a convenient manner for users to selectively apply characteristics or properties to items of content in selected breakpoints, without having to apply the characteristic or property individually to each item of content in every breakpoint.

While the examples provided in this section relate generally to one example of selectively changing the font in a text box across multiple breakpoints, it should be easily understood that this is not intended to be limiting. Any sort of characteristic or property may be changed to any item of content without departing from the scope of the invention. For example, characteristics and properties may include colors, patterns, shading, filters, size, and alignment, to name only a few examples. Furthermore, techniques relating to formatting controls may be employed with any of the responsive design control techniques described herein for additional possibilities for designers to create and edit digital content.

### Make Same Across Breakpoints

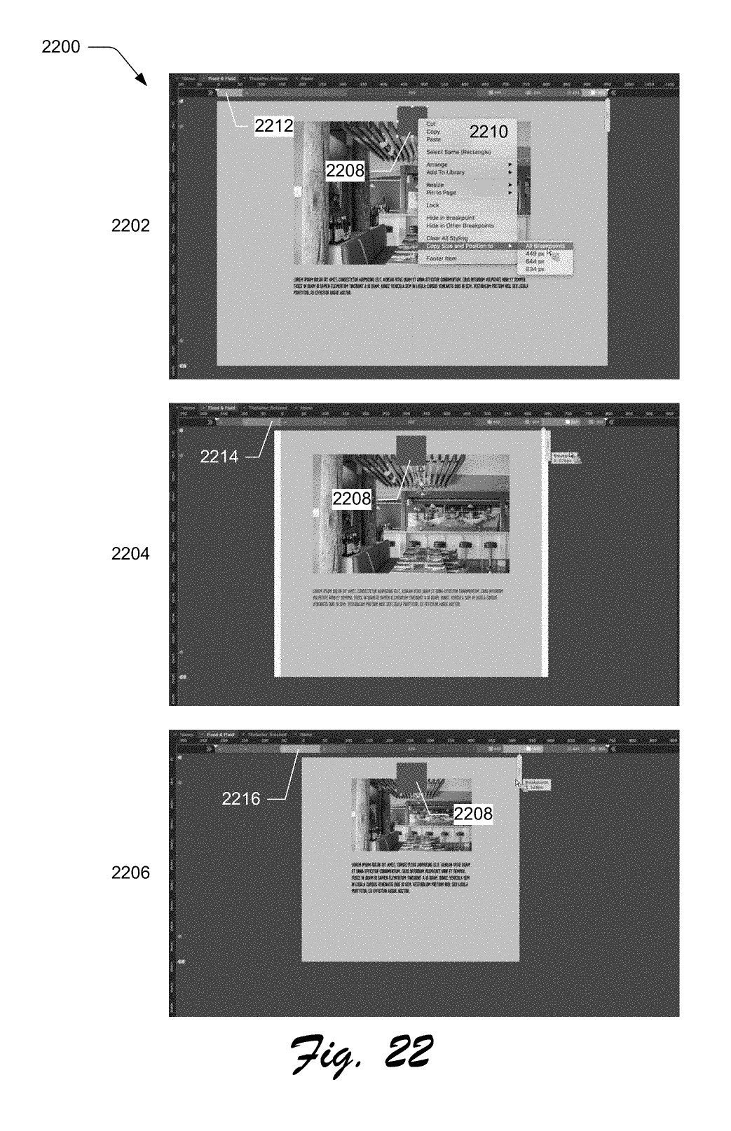

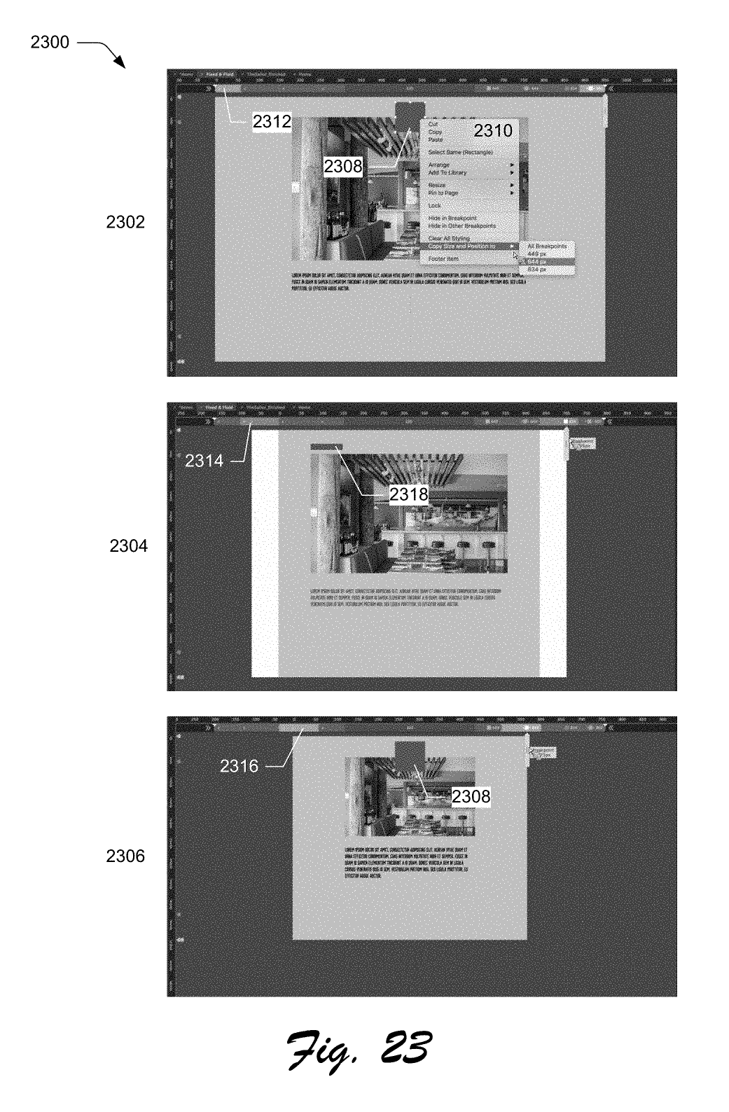

FIG. 22 illustrates a user interface generally at 2200 configured to implement responsive design controls in accordance with one or more implementations, such as the user interface of FIG. 3. FIG. 22 is representative of functionality of the user interface to make characteristics or properties of an item of content the same across all breakpoints. The techniques for making an item of content the same across multiple breakpoints described in relation to FIGS. 22-23 may be used with any or all of the functionalities of responsive design controls described herein. In the representation of the user interface at 2202, a user has selected an item of content 2208, and caused an input to display a drop-down menu 2210. The user may wish to have the item of content 2208 displayed the same on every breakpoint as the current breakpoint 2212 for the particular page they are creating. The drop-down menu 2210 provides the user with selectable options to distribute the same characteristics of the item of content 2208 across multiple breakpoints. Although not pictured, additional options such as “all breakpoints smaller than current one”, “all breakpoints larger than current one”, “all breakpoints within range”, are also contemplated, to name a few examples.

In this example the user may select the option “Copy Size and Position to [symbol] All Breakpoints” highlighted in the representation of the user interface at 2202. To illustrate the effect of this selection, the representation of the user interface at 2204 displays another breakpoint 2214 of the page after the user made the selection. The item of content 2208 is now present in the same position, with the same characteristics, as in the breakpoint 2212. Further, the representation of the user interface at 2206 displays yet another breakpoint 2216 of the page after the user has made the selection. The item of content 2208 again is present in the same position, with the same characteristics, as in the breakpoint 2212. Each of the breakpoints that the user has created for the page will now display the item of content 2208 in the same location and with the same characteristics as the item of content in the breakpoint 2212, without any further user input and without the user navigating to the additional breakpoints. In other words, the user will not have to copy the item of content 2208, select each breakpoint individually, and paste the item of content 2208 on each respective breakpoint, such as in previous techniques. Further, because the item of content 2208 is copied to the same position in each of the breakpoints, the user does not need to worry about whether the item of content has been placed correctly, such as can possibly happen with a traditional copy-and-paste operation.

Turning to FIG. 23, another user interface is illustrated generally at 2300 configured to implement responsive design controls in accordance with one or more implementations, such as the user interface of FIG. 22. FIG. 23 is representative of functionality of the user interface to make characteristics or properties of an item of content the same for a particular, selected breakpoint of multiple breakpoints. In the representation of the user interface at 2302, a user has selected an item of content 2308, and caused an input to display a drop-down menu 2310. The user may wish to have the item of content displayed on the current breakpoint 2312, along with one other breakpoint, for the particular page they are creating. As described above, the drop-down menu 2310 provides the user with selectable options to distribute the same characteristics of the item of content 2308 not only across multiple breakpoints, but to select other breakpoints of the multiple breakpoints.

For instance, the user may select the option “Copy Size and Position to [symbol] 644 px” highlighted in the representation of the user interface at 2302. The “644 px” corresponds to the breakpoint having a size range with a maximum width of 644 pixels. To illustrate the effect of this selection, the representation of the user interface at 2304 displays another breakpoint 2314 of the page after the user made the selection. The breakpoint 2314 may have a size range of 834 pixels, for example. Therefore, as can be seen in the representation of the user interface at 2304, the item of content has not been reproduced on the breakpoint 2314. Instead, an item of content 2318 in the breakpoint 2314 that may correspond to the item of content 2308 in the breakpoint 2312 remains unchanged.

Moving the representation of the user interface at 2306, another breakpoint 2316 of the page is displayed. This breakpoint corresponds to the size range with a maximum width of 644 pixels. Accordingly, in this breakpoint 2316, the item of content 2308 has had its size and position copied from the breakpoint 2312 without any further user input and without the user navigating to the breakpoint 2316 to execute the operation. In other words, the user will not have to copy the item of content 2308, select each particular breakpoint that they wish to copy the item to individually, and paste the item of content 2308 to those particular breakpoints, as in previous techniques. Similar to the above discussion, the user does not need to worry about whether the item of content has been placed correctly, such as can possibly happen with a traditional copy-and-paste operation.

In one or more implementations, formatting across breakpoints may comprise an operation similar to copying and pasting an item from one breakpoint to another, where the item was not previously on the additional breakpoints. Alternatively or additionally, similar to the description above, formatting across breakpoints may comprise conforming an item that is present in multiple breakpoints to the format in the current breakpoint. Either of these actions will cause the item to be the same in the additional selected breakpoint with only one selection procedure, such as the selection procedure described above. The user will not need to visit the additional breakpoints in order for the item to be made the same in the additional selected breakpoints.

Additionally, the techniques relating to formatting across breakpoints should not be limited to the above examples. For instance, a user may initiate a formatting across breakpoints operation with an icon in the user interface, a multi-input gesture, or a modal window, to name a few examples. Further, any sort of characteristic or property may be made the same across breakpoints without departing from the scope of the invention. For example, characteristics and properties may include colors, patterns, shading, filters, size, and alignment, to name only a few examples. Furthermore, techniques relating to making characteristics or properties the same across breakpoints may be employed with any of the responsive design control techniques described herein for additional possibilities for designers to create and edit digital content.

Multiple Breakpoints with Scroll Effects

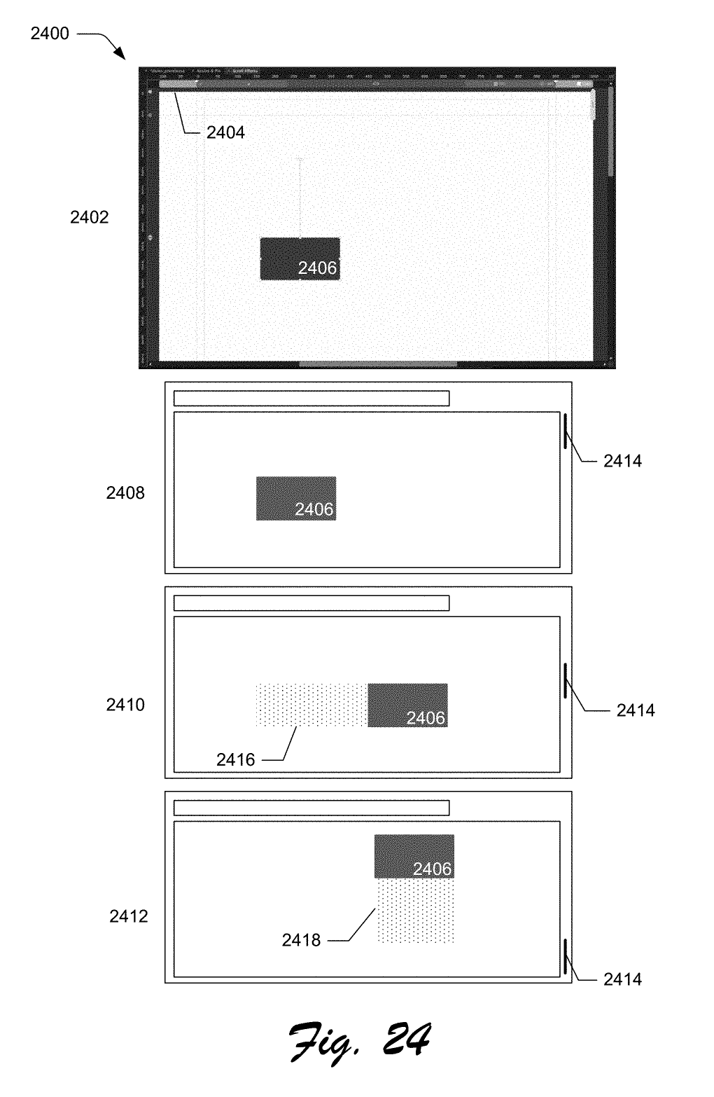

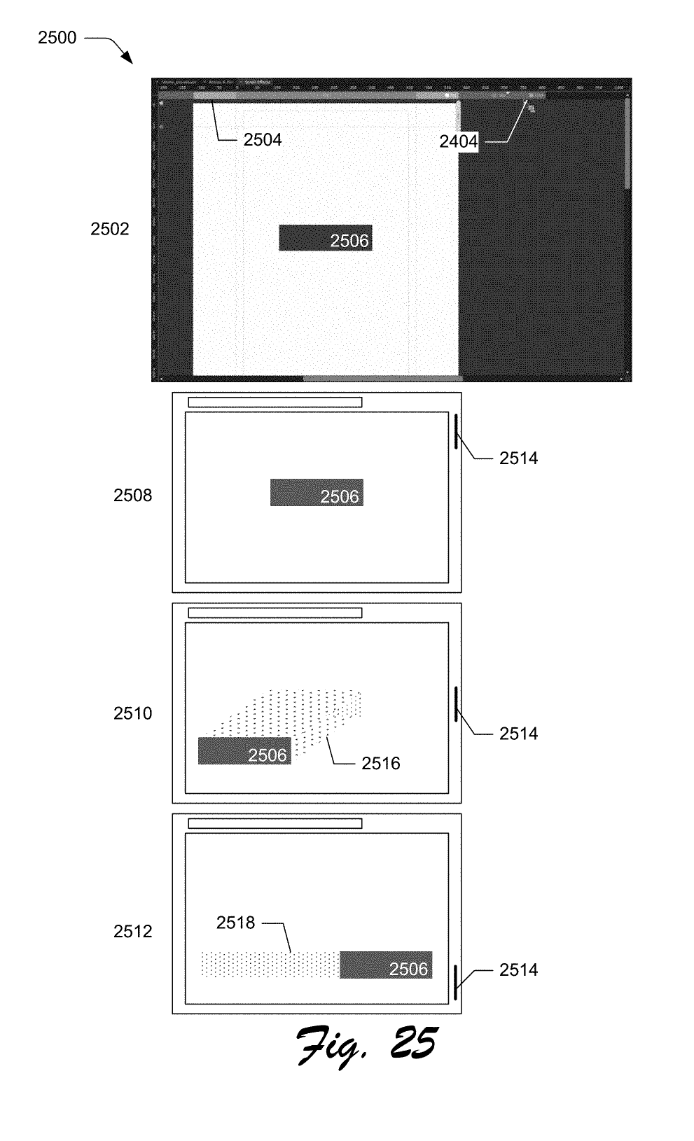

FIG. 24 illustrates a user interface and a browser window generally at 2400 configured to implement responsive design controls in accordance with one or more implementations. FIG. 24 is representative of functionality of the user interface to apply different scroll effects to different breakpoints of a page, such as when the page is displayed in a browser. Techniques for creating multiple breakpoints with scroll effects described in relation to FIGS. 24-25 may be used with any or all of the functionalities of responsive design controls described herein. Scroll effects cause an item of content to change or move in a particular way when a page is scrolled, beyond simply moving with the page as the page is scrolled in a browser. For example, a page displayed in a browser falling in a size range of a small breakpoint may have a first scroll effect, while a page displayed in a browser falling in a size range of a large breakpoint may have a second, different scroll effect.

For example, consider the representation of the user interface at 2402, which displays a breakpoint 2404 having an item of content 2406. In this breakpoint 2404, a user may apply a series of scroll effects to the item of content 2406. The user may then preview the page in a browser, such as the representation of the browser window at 2408. In the representation of the browser window at 2408, a scroll bar 2414 is shown as being at the top of the page. As the user scrolls the browser down, moving to the representation of the browser window at 2410, the scroll bar 2414 also moves down. However, a first scroll effect 2416 applied to the item of content 2406 causes the item of content to move to the right side of the page, rather than moving up as the page scrolls down. When the scroll bar 2414 reaches a certain location, a second scroll effect 2418 applied to the item of content 2406 may cause the item of content 2406 to move up with the page as the page is scrolled.

Turning to FIG. 25, a user interface and a browser window are illustrated at 2500. The representation of the user interface illustrated at 2502 may display the same user interface as depicted in the representation of the user interface at 2402 in FIG. 4. However, in this case, a user has selected a different breakpoint 2504 as the active breakpoint to display content on the design surface, rather than the breakpoint 2404 of FIG. 24. In this breakpoint 2504, the user may apply a different series of scroll effects to the item of content 2506. The user may then preview the page in a browser, such as the representation of the browser window at 2508. It should be noted that the size of the browser window 2508 matches to the breakpoint 2504; and therefore the behavior of the content on the page will correspond to the rules and characteristics applied to that particular breakpoint.

The representation of the browser window at 2508 displays the item of content 2506 on the page, and the scroll bar 2514 indicating that the page is at the top. As the user scrolls the browser down, moving to the representation of the browser window at 2510, the scroll bar 2514 also moves down. A first scroll effect 2516 applied to the item of content 2506 causes the item of content to move diagonally down and left, rather than moving up as the page scrolls down. When the scroll bar 2514 reaches a certain location, a second scroll effect 2518 applied to the item of content 2506 may cause the item of content 2506 to move to the right of the page as the page is scrolled.

A particular notable aspect of this feature is that different scroll effects can be applied to different breakpoints of the same page. The scroll effects 2416 and 2418 depicted in FIG. 24 will take effect when the browser window falls in the size range corresponding to breakpoint 2404. The scroll effects 2516 and 2518 depicted in FIG. 25 will take effect when the browser window falls in the size range corresponding to breakpoint 2504. From the representations of the browser window 2408-2412, to the representations of the browser window 2508-2512, the same page is displayed throughout, even though the size of the browser window may change and the scroll effects displayed on the page may change.

While the examples provided in this section relate generally to one example of multiple breakpoints with scroll effects, it should be easily understood that this is not intended to be limiting. Any sort of scroll effect may be applied to any item of content without departing from the scope of the invention. For example, scroll effects such as speed changes, turning a content item, layering content items, applying color or filters, or custom animations, to name only a few examples. Additionally, scroll effects may be applied to any type of breakpoint, such as fluid breakpoints or fixed breakpoints. Furthermore, techniques relating to multiple breakpoints with scroll effects may be employed with any of the responsive design control techniques described herein for additional possibilities for designers to create and edit digital content.

### Delayed Copy to Additional Breakpoints

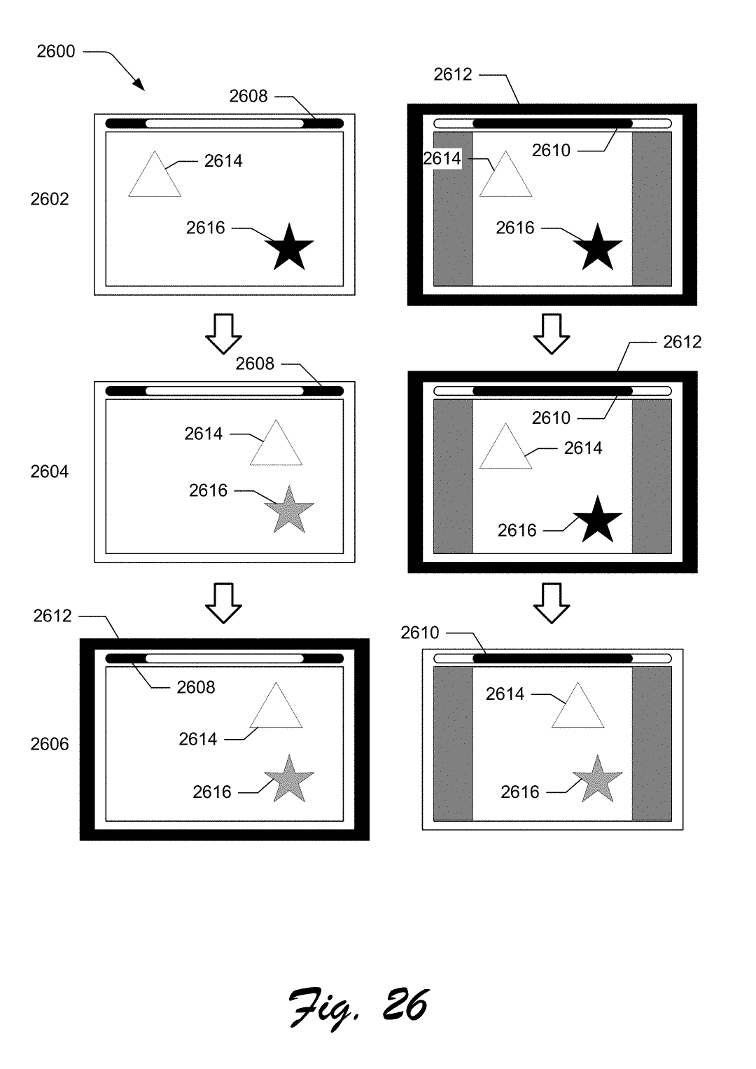

FIG. 26 illustrates a user interface generally at 2600 configured to implement responsive design controls in accordance with one or more implementations. FIG. 26 is representative of functionality of an application displaying the user interface to delay copying changes to content on an active breakpoint to additional breakpoints that are not currently being viewed. The delayed copy functionality described in relation to FIG. 26 may be used with any or all of the functionalities of responsive design controls described herein. Delaying copy of changes made to content in an active breakpoint can save resources in the application and processing units of a computing device running the application, so that the resources may be allocated elsewhere.

For example, consider the two representations of the user interface at 2602, corresponding to a first time t1. The representation of the user interface on the left of 2602 depicts a breakpoints bar 2608 with a large breakpoint indicated as the current, active breakpoint. Two items of content are displayed in the design surface, a triangle 2614 and a star 2616. Also shown in the representation of the user interface at 2601 at time t1 is what the corresponding smaller breakpoint 2610 looks like having the same two items of content 2614 and 2616. However, a border 2612 is surrounding the representation of the breakpoint 2610, indicating that this breakpoint is not currently being displayed to a user. At time t1, only the breakpoint 2608 is displayed to the user.

Moving to the representations of the user interface at 2604, the same breakpoints are pictured at a second time t2. In this representation of the user interface at 2604, a user has edited the content on the page in the active breakpoint 2608. As pictured, the triangle 2614 has been moved to a different location on the page, and the star 2616 has changed color. At the same point in time t2, however, the smaller breakpoint 2610 (indicated as not being displayed by the border 2612) does not reflect the changes that were made to the larger, active breakpoint 2608. Instead, indications of the changes made in the breakpoint 2608 may be stored in a location to be consolidated for delayed copy to additional breakpoints. For example, the user may have changed the color of the triangle 2614 several times, before returning to the original color at time t2. In one or more implementations, these changes will be ignored when the delayed copy occurs, saving processing resources as described above.

Arriving at the representations of the user interface at 2606, the same breakpoints are pictured at a third time t3. In this case, the border 2612 is now surrounding the representation of the larger breakpoint 2608, indicating that this breakpoint is no longer being displayed to the user. Instead, the user has selected the smaller breakpoint 2610 as the active breakpoint to view. When the user selects this breakpoint 2610, the delayed copy action takes place, reflecting the final changes that occurred to the formatting, characteristics, properties, and location in the larger breakpoint 2608. As discussed above, these changes may be consolidated, so that only the final characteristics, properties, and locations of the content items 2614 and 2616 are reflected when the user selects the breakpoint 2610 to view as the active breakpoint. While this description relates to a delayed copy operation to one additional breakpoint, it should be easily understood that the delayed copy may be applied to any number of breakpoints.

### Options for Copying Content Items to Different Documents Having Multiple Breakpoints

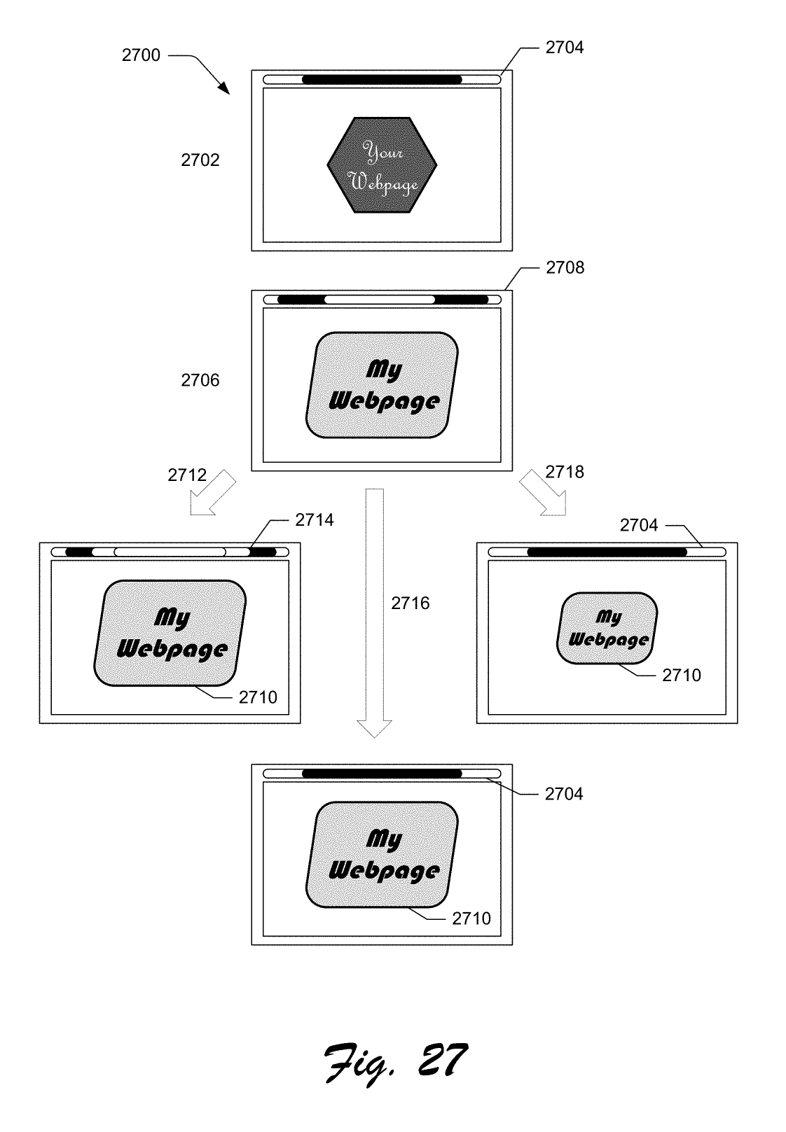

Designers may have numerous ideas of how content items should be copied and pasted when performing such actions between different documents with multiple breakpoints. FIG. 27 provides a user interface generally at 2700 that is representative of functionality to provide users with different copy and paste options between documents having multiple breakpoints in accordance with one or more implementations of responsive design controls. The options for copying content items to different documents having multiple breakpoints described in relation to FIG. 27 may be used with any or all of the functionalities of responsive design controls described herein. While the examples below relate generally to webpage documents, any type of document capable of having multiple breakpoints may be used with the described techniques.

For instance, a representation of a user interface is depicted at 2702 is configured to implement responsive design controls, and displays a webpage document “Your Webpage” that is currently being created. The webpage document that is being created in the representation of the user interface at 2702 has two breakpoints depicted in the breakpoints bar 2704. Suppose that a user wishes to copy and paste an item of content from another webpage document, such as the item of content depicted in the representation of the user interface at 2706. The representation of the user interface at 2706 displays a different webpage document having different content items than the representation of the user interface at 2702. Additionally, the webpage document in the representation of the user interface at 2706 has three breakpoints displayed in the breakpoint bar 2708, as opposed to two breakpoints for the webpage document in the representation of the user interface at 2702. In one or more embodiments, some or all of the breakpoints of the respective webpage documents are also different sizes.

To copy the item of content 2710 from the webpage document in the representation of the user interface at 2706, the user may select the item of content 2710 and press “Ctrl+C” on a keyboard, for example, to copy the item of content 2710. A number of other inputs are also contemplated to implement a copy action. The user may then wish to paste the item of content 2710 to the webpage document depicted in the representation of the user interface at 2702. The user may return to the webpage document in the representation of the user interface at 2702, and “right click” to display a menu which may contain different paste options for the item of content 2710, although other inputs to display paste options are also contemplated.

A first option that may be selected by the user for pasting the item of content 2710 is to create missing breakpoints in the webpage document receiving the item of content 2710 in the paste operation. Selection of this first option, “Create Missing Breakpoints,” is represented by the arrow 2712. When the user selects the “Create Missing Breakpoints” option, the item of content 2710 is pasted into the webpage document depicted in the representation of the user interface at 2702. In addition, new breakpoints are created that were present in the representation of the user interface at 2706 and not present in the representation of the user interface at 2702. This may result in the webpage document in the representation of the user interface at 2702 having four total breakpoints in the breakpoint bar 2714; the original two breakpoints and two new breakpoints from the webpage document in the representation of the user interface at 2706. In this example, the outermost breakpoints of the two webpage documents are the same size. Therefore there was not a “missing” breakpoint at this size, so a breakpoint is not added at this size.

The breakpoint bar 2714 displays one of the breakpoints in the design surface of the user interface, where the item of content 2710 has been pasted as part of a copy and paste operation. In one or more implementations, the new breakpoints that were created as part of the “Create Missing Breakpoints” selection may copy content from breakpoints of the source of the item of content 2710 into corresponding newly created breakpoints. Alternatively, the new breakpoints that were created as part of the “Create Missing Breakpoints” selection may be blank, or may adapt the size and position of content from the webpage document receiving the pasted content onto the newly created breakpoints.

A second option that may be selected by the user for pasting the item of content 2710 is to ignore any missing breakpoints that the webpage document receiving the item of content 2710 may not have when compared to the webpage document from which the item of content 2710 was copied. Selection of this second option, “Ignore Missing Breakpoints,” is represented by the arrow 2716. When the user selects the “Ignore Missing Breakpoints” option, the item of content 2710 is pasted into the webpage document depicted into the representation of the user interface at 2702 without any breakpoints being added. Therefore, only the item of content 2710 is pasted into the webpage document in the representation of the user interface at 2702, and the breakpoints in the breakpoint bar 2704 remain the same.

A third option that may be selected by the user for pasting the item of content 2710 is to try to match to a closest breakpoint. Selection of this third option, “Match Closest Breakpoint,” is represented by the arrow 2718. When the user selects the “Match Closest Breakpoint” option, the application will alter the size of the item of content 2710 based on the size of a breakpoint on the webpage document receiving the item of content 2710 that most closely matches a size of the breakpoint from which the item of content 2710 originated.

To illustrate this concept, consider the following. The item of content 2710 is copied from the webpage document illustrated in the representation of the user interface at 2706, from a breakpoint having an example size of 1000 pixels. In the breakpoint illustrated in the representation of the user interface at 2706, the item of content 2710 has a width of 500 pixels. The user then moves to the webpage document in the representation of the user interface at 2702, and executes the “Match Closest Breakpoint” option as represented by the arrow 2718. Consider that the larger of the two breakpoints in the representation of the user interface at 2702, in this example, is a size of 1500 pixels, while the smaller of the two breakpoints is a size of 800 pixels. Because the smaller, 800 pixel breakpoint is the closest in size to the breakpoint where the item of content 2710 originated (1000 pixels), the item of content 2710 will be pasted onto the 800 pixel breakpoint in the webpage document illustrated in the representation of the user interface at 2702. Additionally, the width of the item of content 2710 is changed proportionally to reflect the difference in size of the breakpoints, going from 500 pixels in width to 400 pixels in width when the item of content 2710 is pasted to the receiving webpage document.

The “Match Closest Breakpoint” option does not create any new breakpoints when items of content are pasted into a receiving document. Instead, the “Match Closest Breakpoint” option merges properties of the item of content being pasted with existing properties of the paste location. While size of an item of content is described above as a property of the item of content 2710, numerous other properties are contemplated that may be merged as part of a “Match Closest Breakpoint” operation. For example, these may include theme characteristics, colors, fonts, effects, styles, or other properties that an item of content may have.

### Master Page Breakpoint Inheritance

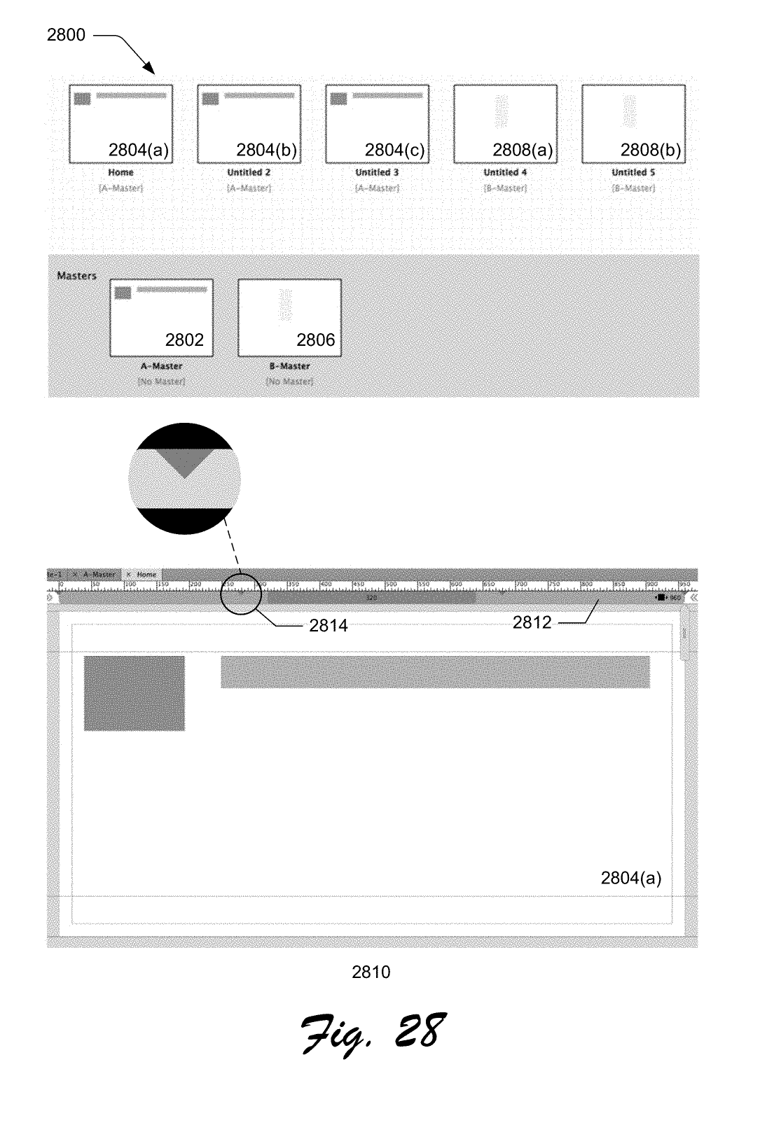

FIG. 28 illustrates various implementations of a master page generally at 2800, along with various ways that master pages may be implemented with responsive design controls. More specifically, FIG. 28 is representative of functionality of a user interface to display a selectable indicator to create a breakpoint at a location on a page, where the selectable indicator corresponds to a breakpoint on a master page of the page. A brief discussion of master page functionality is provided for context, followed by additional details regarding master page breakpoint inheritance.

As discussed above, master pages hold items of content that apply to multiple pages. In an example, a master page for a website may comprise items of content such as a company logo and a navigation menu that are meant to be identical for all pages on the website. This functionality is achievable without utilizing master pages, but designers will have to duplicate each of these items on every page of a website they are creating. Moreover, if the designer needs to make edits to one of these items, the designer will need to visit each page to make the changes. Using a master page allows the designer to only have to create and edit these content items in one place, reducing working time and eliminating potential errors. Similar to other pages described herein, master pages may have more than one breakpoint. Further, any page (normal pages or master pages) can inherit content from another master page, or may skip inheritance, which may be indicated by “No Master” in a user interface.

Returning to FIG. 28, a master page A-Master 2802 is depicted with two content items. Three “normal” pages (i.e., not master pages) are also depicted that use A-Master 2802: Home page 2804(a), Untitled 2 page 2804(b), and Untitled 3 page 2804(c). As shown, the items of content appearing on A-Master 2802 also appear on the normal pages 2804(a)-(c) that depend from A-Master 2802. Additionally, another master page B-Master 2806 is shown with a single content item. Normal pages 2808(a) and 2808(b) use B-Master 2806, also having the same content item displayed in B-Master 2806. While only two “layers” of pages are shown—a first layer with A-Master 2802 and B-Master 2806, and a second layer with normal pages 2804(a)-(c) and 2808(a) and (b)—more than two layers are contemplated, including master pages having additional master pages.

Furthermore, even though only content items are shown as being inherited from Master-A 2802 and Master-B 2806, the same concept can also apply to breakpoints. If a master page defines breakpoints at 400 pixels and at 960 pixels, these breakpoints can also be made available on all pages that use that master page. While any page can define its own breakpoints, the page's own defined breakpoints may be in addition to breakpoints defined by the page's master page which are already present when the page is created from the master page.

In the current example, the Home page 2804(a) uses A-Master 2802 as discussed above. In the representation of the user interface at 2810, the Home page 2804(a) is depicted as being displayed in the design surface of the user interface, along with the content items from A-Master 2802. The Home page 2804(a) has only one breakpoint 2812 with a size of 960 pixels. However, selectable indicators 2814 are visible on the breakpoint 2812 that indicate the presence of an additional breakpoint on A-Master 2802 which is not present on the Home page 2804(a). These selectable indicators 2814 correspond to the size of the breakpoint on A-Master 2802 that is not present on the Home page 2804(a) at 400 pixels. Further, the indicators 2814 are selectable to cause a scrubber to jump to the exact size of the breakpoint that is not present on the Home page 2804(a), so the user may quickly create a breakpoint on the Home page 2804(a) at this size if desired.

### Cropped Content Warning

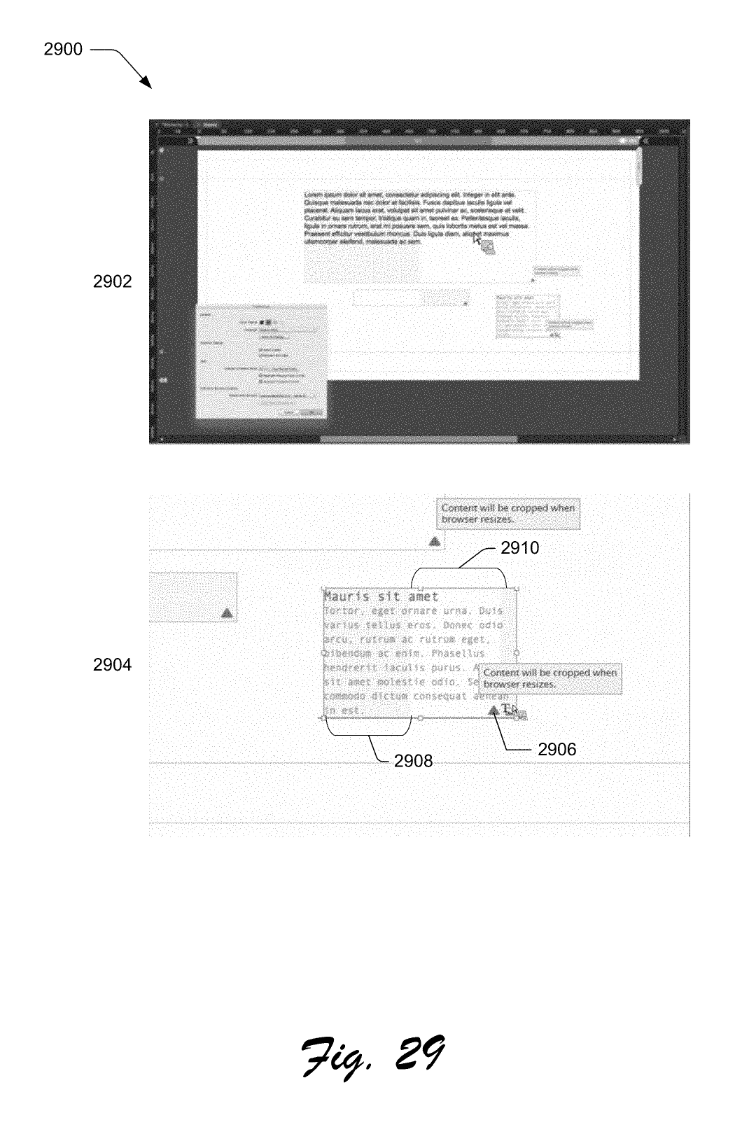

FIG. 29 illustrates a user interface generally at 2900 configured to implement responsive design controls in accordance with one or more implementations. FIG. 29 is representative of functionality of the user interface to display a cropped content warning responsive to an item of content falling outside of a size limit of a breakpoint. The cropped content warning described in relation to FIG. 29 may be used with any or all of the functionalities of responsive design controls described herein. For example, different display devices have different rules on how content will be displayed when the content is formatted to be larger than the area of the display device. It can be difficult for designers to accommodate the layout of their content to each and every display device and how the respective display devices will shuffle and reorganize the layout to fit the device.

Further, when designing a page, it may be difficult for a designer to see when an item of content may fall outside of the size limit of a breakpoint, especially if it only extends beyond the size limit by a few pixels. However, when the content extends beyond the size limit, this may cause a display device to drastically alter the desired page layout to fit all of the content on the display device, or to display scroll bars. This can cause frustration for designers to go back and find the one piece of content that extends beyond the boundary of the breakpoint. It may also irritate users when page layouts are in disarray, or when users must scroll back and forth on a page to view all of a page's content.

The representation of the user interface at 2902 displays several items of content that have cropped content warnings. These items of content may have been placed outside of the size range of a breakpoint, the breakpoint may have been made smaller than the locations of the items of content, or the content may have been resized to fall outside of the size range of the breakpoint, to name a few examples. A zoomed-in illustration of a portion of the user interface is displayed at 2904. An indicator 2906 is displayed on an item of content that will be cropped when the browser is resized to a particular breakpoint. Further, an overlay 2908 is present over the item of content, showing how the content will be cropped when the browser resizes. The content that will remain unchanged when the browser resizes is show in the section 2910. The overlay 2908 and the portion of the content that remains unchanged 2910 give the user a visual of how the content will look when the browser is resized. It also gives the user an indication of how much the user will need to move or resize the content in order to fit the content in a breakpoint without being cropped. This overlay can be applied to any item of content, including rotated items of content.

### Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

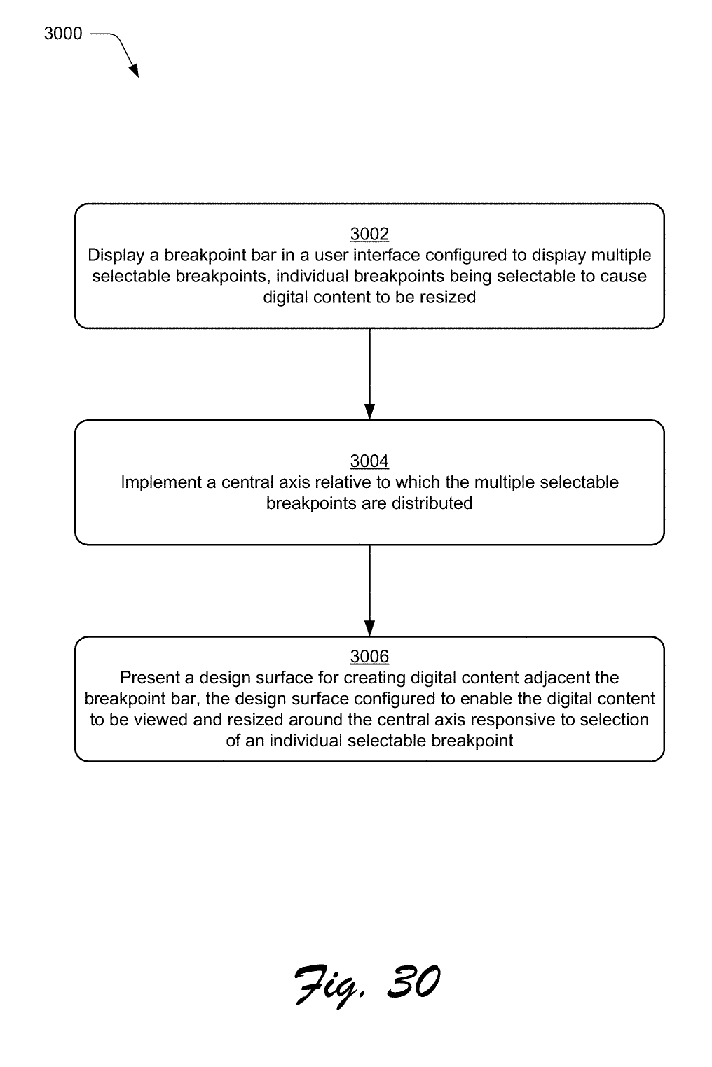

FIG. 30 depicts a flow diagram, generally at 3000, for an example procedure to perform responsive design controls. The procedure depicted in FIG. 30 can be implemented by way of a suitably configured computing device and application, such as the content editing application 104 of FIG. 1. The procedure of FIG. 30 can also be implemented by way of other functionality described in relation to FIGS. 1-29 and 34. Individual operations and details discussed in relation to FIG. 30 may also be combined in various ways with operations and details discussed herein in relation to the example procedures of FIGS. 31-33.

A breakpoint bar is displayed in a user interface at block 3002. The breakpoint bar is configured to display multiple selectable breakpoints. Individual breakpoints in the breakpoint bar are selectable to cause digital content to be resized, examples of which are provided above. The individual breakpoints in the breakpoint bar may be selected in various ways, such as by clicking on the individual breakpoints, using a keyboard shortcut, moving a scrubber to within a size range of an individual selectable breakpoint, or selecting a breakpoint from a menu, to name some examples. The individual breakpoints may correspond to a class of display devices that fall into a particular size range. Breakpoints are useful because users may want content to behave differently on the same page across different device sizes, and thus each breakpoint allows users to assign rules, characteristics, and properties to content in each breakpoint so that the content will behave a particular way on a certain class of devices. For instance, a first, small breakpoint may correspond to a common size range of smartphone displays, a second larger breakpoint may correspond to a common size range of tablet displays, and a third even larger breakpoint may correspond to a common size range of desktop computer displays.

A central axis is implemented relative to which the multiple selectable breakpoints are distributed (block 3004), although the central axis is not visible unless an item with page-center pinning is selected. For example, the breakpoints can be displayed in a layered fashion such that the smallest breakpoint is in the forefront of the breakpoint bar, the next largest breakpoint is underneath the smallest breakpoint but is visible by how far it extends beyond the smallest breakpoint, and so on until the largest breakpoint which makes up the bottom layer of breakpoints. Each breakpoint thus has a pair of selectable regions, all except the smallest breakpoint which has an undivided selectable region in the forefront of all of the breakpoints. Because the multiple selectable breakpoints are distributed relative to the central axis, each selectable region is the same size on either side of the axis from which it extends beyond the layer above it. The smallest, top layer is also aligned relative to the central axis such that the smallest layer is distributed evenly on both sides of the central axis.

A design surface is presented for creating digital content adjacent the breakpoint bar (block 3006). The design surface is configured to enable the digital content to be viewed and resized around the central axis responsive to selection of an individual selectable breakpoint. For instance, a user may select a breakpoint by clicking on the breakpoint in the breakpoint bar. Content will automatically be resized and centered based on the rules, characteristics, and properties applied to content of the selected breakpoint. Further, having a pair of selectable regions for each breakpoint (other than the smallest breakpoint) allows for a user to select the breakpoints on either side, and have the content on a design surface adjacent the breakpoint bar be positioned and sized along the central axis corresponding to the selected breakpoint, regardless of which side of the breakpoint was selected.

In one example, when a user clicks and releases within any part of the selectable region of the breakpoint, the scrubber will jump to the outer bound of the breakpoint's selectable region and resize the content in the design surface accordingly. In another example, a user may click and drag within the selectable region, causing the scrubber to snap to the corresponding location of the mouse pointer until the mouse is released. In this example, the scrubber may be used to resize the content in the design surface in a more granular manner than when the selectable region is selected with a single mouse click. Using the scrubber also allows a user to resize the page not just from breakpoint to breakpoint, but also resize the page within a selected breakpoint. When the scrubber is used to resize the page, the content on the page is also resized relative to the central axis.

FIG. 31 depicts a flow diagram, generally at 3100, for an example procedure to perform responsive design controls. The procedure depicted in FIG. 31 can be implemented by way of a suitably configured computing device and application, such as the content editing application 104 of FIG. 1. The procedure of FIG. 31 can also be implemented by way of other functionality described in relation to FIGS. 1-29 and 34. Individual operations and details discussed in relation to FIG. 31 may also be combined in various ways with operations and details discussed herein in relation to the example procedures of FIGS. 30, 32, and 33.

A user interface is presented in a digital media environment for creating custom digital content (block 3102). The environment may include a computing device having a content editing application with various modules, as discussed above. In the user interface, a page in a design surface is exposed to display the custom digital content (block 3104). The design surface may be configured to display a page of digital content having multiple breakpoints. The breakpoints may each have distinctive rules for how the content will behave on the page when displayed in a browser having a size corresponding to the respective breakpoint, as discussed in detail above.

In the user interface, a design control having selectable options is exposed. One of the selectable options is a width option that may be selected and applied to an item of content in the design surface (block 3106). The design control may be drop-down menu, where the width option is one of the options in the drop-down menu. Alternatively or additionally, the design control may be an icon representative of an item of content, where the width option is represented diagrammatically as part of the icon representative of the item of content. Other embodiments of design controls with selectable options can also be provided.

Responsive to the width option being selected to apply to an item of content displayed on the design surface, a width of the item of content is automatically changed proportionally in response to a change in width of the page (block 3108). As discussed above, the size (including the width) of the page may be changed in the design surface, such as by selecting different breakpoints or moving a scrubber in the design surface. Alternatively or additionally, the size of the page may be changed in a browser window, either previewing or viewing the page. Changing the size of the page in the browser window may comprise manually changing the size of the browser window on a desktop monitor, for instance, causing the size of the page to change. Changing the size of the page in the browser window may also comprise viewing the page on computing devices of different display sizes, such as a smart phone or a laptop computer. Regardless of the manner that causes the size of the page to change, if an item of content has the width option applied, the item of content will change proportionally in response to a width of the page changing.

In one or more implementations, the item of content will not change in size if the height of the page changes, as the width option only corresponds to the width of the item of content changing as the width of the page changes. However, additional functionality may be provided via another selectable option to change the height and width of an item of content proportionally in response to the height and width of the page changing, as discussed above. Additional options can also be provided, such as a height option that causes the height of an item of content to change as the height of the page changes, in but one example.

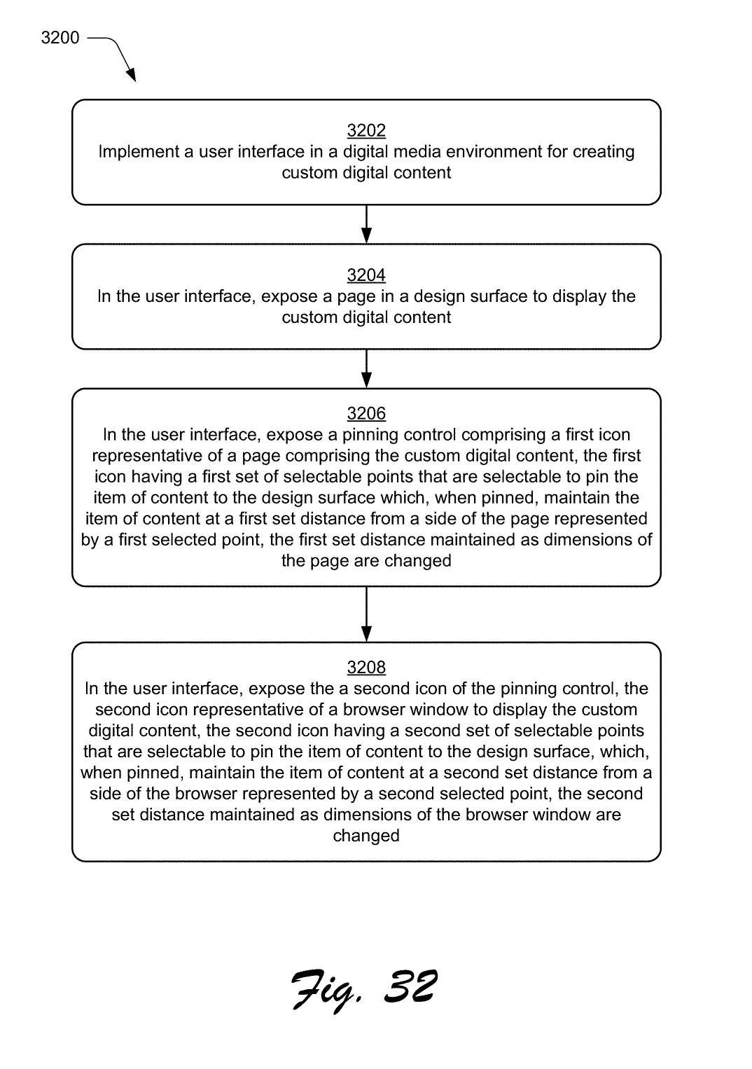

FIG. 32 depicts a flow diagram, generally at 3200, for an example procedure to perform responsive design controls. The procedure depicted in FIG. 32 can be implemented by way of a suitably configured computing device and application, such as the content editing application 104 of FIG. 1. The procedure of FIG. 32 can also be implemented by way of other functionality described in relation to FIGS. 1-29 and 34. Individual operations and details discussed in relation to FIG. 32 may also be combined in various ways with operations and details discussed herein in relation to the example procedures of FIGS. 30, 31, and 33.

A user interface is presented in a digital media environment for creating custom digital content (block 3202). The environment may include a computing device having a content editing application with various modules, as discussed above. In the user interface, a page in a design surface is exposed to display the custom digital content (block 3204). The design surface may be configured to display a page of digital content having multiple breakpoints. The breakpoints may each have distinctive rules for how the content will behave on the page when displayed in a browser having a size corresponding to the respective breakpoint, as discussed in detail above.

A pinning control is exposed in the user interface (block 3206). The pinning control comprises a first icon representative of a page comprising the custom digital content. The first icon has a first set of selectable points that are selectable to pin the item of content to the page. When the item of content is pinned to the page, the item of content maintains a first set distance from a side of the page represented by a first selected point. The first set distance is maintained as dimensions of the page are changed, either in the design surface or in a browser.

The selectable points of the first icon may be generally aligned with the left, center, and right of the icon representative of the page comprising the custom digital content. Therefore, in an example, if the item of content is pinned to the page using the right selectable point, the item of content will maintain a set distance relative to the right side of the page. Maintaining the set distance relative to the page generally relates to the page being resized, either in the design surface or in a browser, and does not cause the item of content to maintain the set distance when the page is scrolled. Additional details regarding pinning items relative to a page are discussed in greater detail above.

A second icon of the pinning control is exposed in the user interface (block 3208). The second icon of the pinning control is representative of a browser window to display the custom digital content, and has a second set of selectable points that are selectable to pin the item of content relative to the browser window. When one of these points is selected, the item of content maintains a second set distance from a side of the browser represented by the second selected point. This second set distance is maintained as dimensions of a browser window displaying the page are changed. Additionally, this set distance may be maintained as the page containing the item of content is scrolled in the browser, as discussed in detail above.

The selectable points of the second icon may be generally aligned with the a top left, a top middle, a top right, a bottom left, a bottom middle, and a bottom left location of the browser window. Therefore, if the item of content is pinned to the browser window using a bottom-middle selectable point, then the item of content will maintain a set distance relative to the bottom-middle of the browser on the page. Maintaining the set distance relative to the browser window relates to both the page being resized with the browser window, and when the page is scrolled in the browser. Additional details regarding pinning items relative to a browser are discussed in greater detail above.

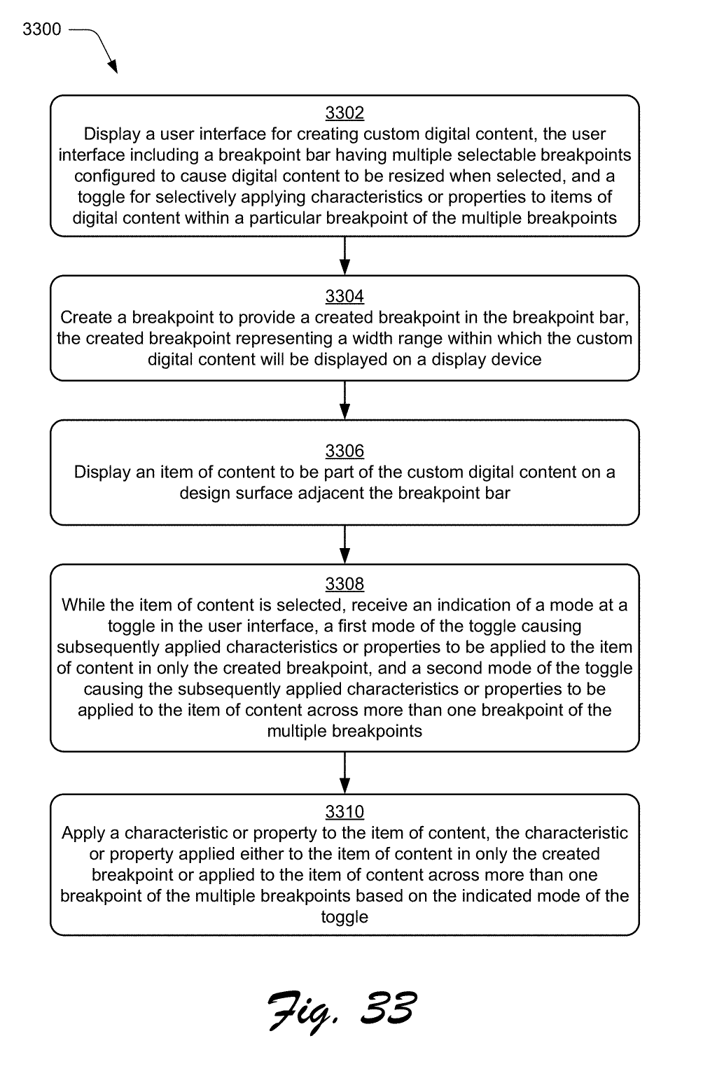

FIG. 33 depicts a flow diagram, generally at 3300, for an example procedure to perform responsive design controls. The procedure depicted in FIG. 33 can be implemented by way of a suitably configured computing device and application, such as the content editing application 104 of FIG. 1. The procedure of FIG. 33 can also be implemented by way of other functionality described in relation to FIGS. 1-29 and 34. Individual operations and details discussed in relation to FIG. 33 may also be combined in various ways with operations and details discussed herein in relation to the example procedures of FIGS. 30-32.

A user interface is displayed for creating custom digital content (block 3302). The user interface includes a breakpoint bar having multiple selectable breakpoints configured to cause digital content to be resized when selected. The user interface also includes a toggle for selectively applying characteristics or properties to items of digital content within a particular breakpoint of the multiple breakpoints. The breakpoints may each have distinctive rules for how the content will behave on the page when displayed in a browser having a size corresponding to the respective breakpoint, as discussed in detail above. Selection of a breakpoint may be by way of clicking on a representation of the breakpoint in the breakpoint bar, or a click-and-drag input on a scrubber which causes the page to be resized in a design surface from one breakpoint to another, to name a few examples.

A breakpoint is created to provide a created breakpoint in the breakpoint bar (block 3304). The created breakpoint represents a width range within which the custom digital content will be displayed on a display device. Examples of possible display devices which may fall into a particular size range of the breakpoint include, but are not limited to, wearable devices, smart phones, tablets, laptop computers, desktop computers, televisions, and projector screens. While the class of display device generally determines the size at which a page will be displayed, this is not always the case. For example, a browser window may be resized in a desktop monitor display to fall within the size range of a smaller breakpoint. In one or more implementations, the size of the browser window will determine the rules that govern how the page is displayed, rather than being determined by the size of the screen on which the page is displayed.

An item of content to be part of the custom digital content is displayed on a design surface adjacent the breakpoint bar (block 3306). For example, the item of content may be a block of text that will appear on a page that corresponds to the custom digital content. Alternatively or additionally, the item of content may be a shape, photograph, video, table, chart, or drawing, to name some examples. Then, while the item of content is selected, an indication of a mode at a toggle in the user interface is received (block 3308). A first mode of the toggle causes subsequently applied characteristics or properties to be applied to the item of content in only the created breakpoint. A second mode of the toggle causes subsequently applied characteristics or properties to be applied to the item of content across more than one breakpoint of the multiple breakpoints. For example, the second mode of the toggle may cause characteristics or properties to be applied to the item of content across every breakpoint of the multiple breakpoints. When a mode of the toggle is selected, characteristics or properties will be applied to the item of content either in only the created breakpoint or across multiple breakpoints, depending on the selected mode, without any further user input.

Next, a characteristic or property is applied to the item of content (block 3310). The characteristic or property is applied either to the item of content in only the created breakpoint or applied to the item of content across more than one breakpoint of the multiple breakpoints based on the selected mode of the toggle. For instance, if the item of content is a block of text, the characteristic may be a change of font, color, size, or text effect. Characteristics of a block of text are provided only as an example. Any characteristic or property may be changed to a block of text, the examples of possible items of content provided above, of any other item of content that user may wish to include as part of their custom digital content. Additional details for applying characteristics and properties across selected breakpoints are discussed above.

Having considered example methods in accordance with one or more embodiments, consider now an example system that can be utilized to implement the principles described above.

### Example System

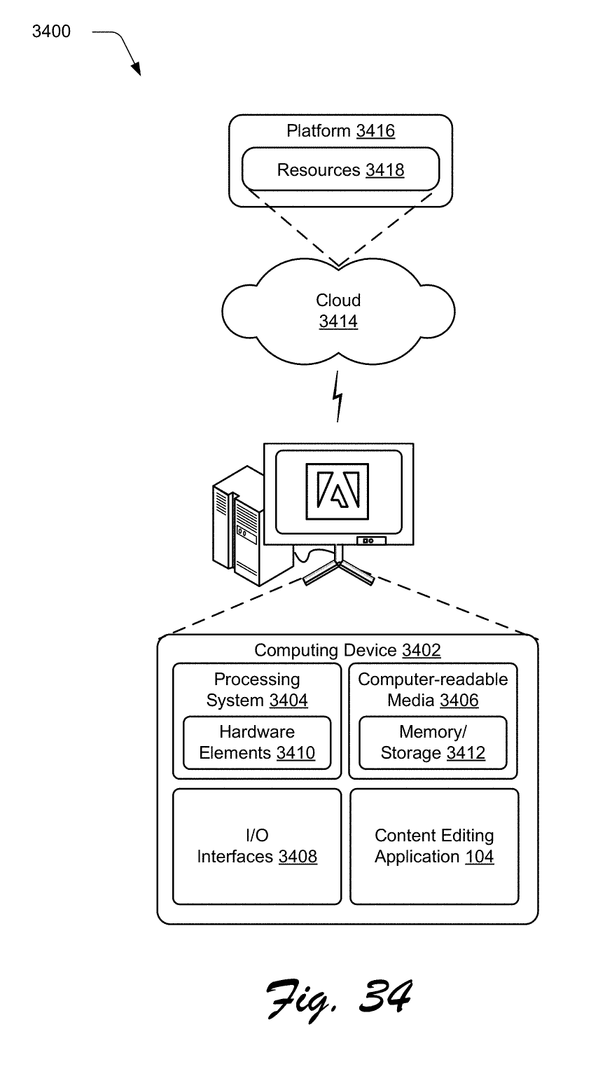

FIG. 34 illustrates generally at 3400 an example system that includes an example computing device 3402 that is representative of one or more computing systems and/or devices that may implement the various techniques described herein. The computing device 3402 may be, for example, a server of a service provider, a device associated with a client (e.g., a client device), an on-chip system, and/or any other suitable computing device or computing system.

The example computing device 3402 as illustrated includes a processing system 3404, one or more computer-readable media 3406, and one or more I/O interfaces 3408 that are communicatively coupled, one to another. Although not shown, the computing device 3402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 3404 is representative of functionality to perform one or more operations using hardware. Accordingly, the processing system 3404 is illustrated as including hardware elements 3410 that may be configured as processors, functional blocks, and so forth. This may include implementation in hardware as an application specific integrated circuit or other logic device formed using one or more semiconductors. The hardware elements 3410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 3406 is illustrated as including memory/storage 3412. The memory/storage 3412 represents memory/storage capacity associated with one or more computer-readable media. The memory/storage 3412 may include volatile media (such as random access memory (RAM)) and/or nonvolatile media (such as read only memory (ROM), Flash memory, optical disks, magnetic disks, and so forth). The memory/storage 3112 may include fixed media (e.g., RAM, ROM, a fixed hard drive, and so on) as well as removable media (e.g., Flash memory, a removable hard drive, an optical disc, and so forth). The computer-readable media 3106 may be configured in a variety of other ways as further described below.

Input/output interface(s) 3408 are representative of functionality to allow a user to enter commands and information to computing device 3402, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 3402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 3402. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Thus, computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 3402, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 3410 and computer-readable media 3406 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the content editing application 104, various modules 106-128, and other program modules may be implemented as one or more instructions and/or logic embodied on some form of computer-readable storage media and/or by one or more hardware elements 3410. The computing device 3402 may be configured to implement particular instructions and/or functions corresponding to the software and/or hardware modules. Accordingly, implementation of modules as a module that is executable by the computing device 3402 as software may be achieved at least partially in hardware, e.g., through use of computer-readable storage media and/or hardware elements 3410 of the processing system. The instructions and/or functions may be executable/operable by one or more articles of manufacture (for example, one or more computing devices 3402 and/or processing systems 3404) to implement techniques, modules, and examples described herein.

As further illustrated in FIG. 34, the example system enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system of FIG. 34, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 3402 may assume a variety of different configurations, such as for computer, mobile, and camera uses. Each of these configurations includes devices that may have generally different constructs and capabilities, and thus the computing device 3402 may be configured according to one or more of the different device classes. For instance, the computing device 3402 may be implemented as the computer class of a device that includes a personal computer, desktop computer, a multi-screen computer, laptop computer, netbook, and so on. The computing device 3402 may also be implemented as the mobile class of device that includes mobile devices, such as a mobile phone, portable music player, portable gaming device, a tablet computer, a multi-screen computer, and so on.

The techniques described herein may be supported by these various configurations of the computing device 3402 and are not limited to the specific examples of the techniques described herein. This is illustrated through inclusion of the content editing application 104 on the computing device 3402. The functionality represented by the content editing application 104 and other modules/applications may also be implemented all or in part through use of a distributed system, such as over a “cloud” 3414 via a platform 3416 as described below.

The cloud 3414 includes and/or is representative of a platform 3416 for resources 3418. The platform 3416 abstracts underlying functionality of hardware (e.g., servers) and software resources of the cloud 3414. The resources 3418 may include applications and/or data that can be utilized while computer processing is executed on servers that are remote from the computing device 3402. Resources 3418 can also include services provided over the Internet and/or through a subscriber network, such as a cellular or Wi-Fi network.

The platform 3416 may abstract resources and functions to connect the computing device 3402 with other computing devices. The platform 3416 may also serve to abstract scaling of resources to provide a corresponding level of scale to encountered demand for the resources 3418 that are implemented via the platform 3416. Accordingly, in an interconnected device embodiment, implementation of functionality described herein may be distributed throughout the system of FIG. 34. For example, the functionality may be implemented in part on the computing device 3402 as well as via the platform 3416 that abstracts the functionality of the cloud 3414.

### CONCLUSION

Although the example implementations have been described in language specific to structural features and/or methodological acts, it is to be understood that the implementations defined in the appended claims are not necessarily limited to the specific features or acts described. Rather, the specific features and acts are disclosed as example forms of implementing the claimed features.

What is claimed is:

1. A system comprising:
one or more processors; and
one or more computer-readable media comprising instructions which, when executed by the one or more processors, implement a user interface comprising:
a breakpoint bar configured to display multiple selectable breakpoints, individual breakpoints being selectable to cause digital content to be resized;
a central axis relative to which the multiple selectable breakpoints are distributed, the central axis configured to be hidden from view in the user interface; and
a design surface for creating digital content adjacent the breakpoint bar, the design surface configured to enable the digital content to be viewed and resized around the central axis responsive to selection of an individual selectable breakpoint.

2. The system of claim 1, wherein each breakpoint has a different size, and the multiple breakpoints are displayed in a layered fashion such that a smallest breakpoint of the multiple breakpoints is in the forefront of the breakpoint bar and the breakpoints increase in size as the breakpoints descend in layers.

3. The system of claim 2, wherein each of the multiple breakpoints, other than a smallest breakpoint, has a pair of selectable regions that correspond in size to how far a respective breakpoint layer extends beyond a breakpoint in an above layer.

4. The system of claim 1, wherein the breakpoint bar is further configured to display an active breakpoint associated with content that is currently being edited or created in the design surface for the defined size of the breakpoint, the active breakpoint being displayed in a color unique to the particular breakpoint that is active.

5. The system of claim 1, wherein the breakpoint bar comprises a max-width toggle having two modes, wherein:
a first mode, when selected, causes the digital content to remain a size of a largest breakpoint of the multiple breakpoints as a page comprising the digital content is resized to be larger than the largest breakpoint; and
a second mode, when selected, causes the digital content to continue to resize proportionally as the page comprising the digital content is resized to be larger than the largest breakpoint.

6. The system of claim 1, wherein the breakpoint bar comprises a minimum-width indicator that represents a set width at which the digital content does not resize any smaller, regardless of the width of the design surface or a width of a browser displaying the digital content.

7. The system of claim 6, wherein the design surface is configured to display an overlay on the digital content in the design surface, the overlay representing content that will not be visible when the browser displaying the page is resized to be smaller than the set width.

8. The system of claim 1, wherein the user interface is configured to enable creation of a page comprising the digital content having both fixed and fluid breakpoints, wherein a fluid breakpoint causes items of content on the page to be resized proportionally as the page is resized within the fluid breakpoint, and wherein a fixed breakpoint causes the items of content on the page to remain a fixed size and location as the page is resized within the size range of the fixed breakpoint.

9. The system of claim 1, wherein the digital content can include an item of content having a first scroll effect and a second scroll effect, wherein the first scroll effect is applied to the item of content in a first breakpoint of the multiple breakpoints and the second scroll effect is applied to the item of content in a second breakpoint of the multiple breakpoints.

10. The system of claim 1, wherein the user interface is configured to display a warning on an item of content in the design surface responsive to the item of content extending beyond a maximum size of a breakpoint in which the content is displayed.

11. In a digital media environment for creating custom digital content, a computing device configured to implement a user interface comprising:
a design surface to display the custom digital content;
a resizing control having selectable options, one of the selectable options being a width option which may be selected and applied to an item of content displayed on a page on the design surface, wherein when selected to apply to the item of content displayed on the design surface, causes a width of the item of content to automatically change proportionally in response to a change in width of the page; and
a pinning control comprising:
a first icon representative of the page comprising the custom digital content, the first icon having a first set of selectable points that are selectable to pin the item of content to the page which, when pinned, maintain the item of content at a first set distance from a side of the page represented by a first selected point, the first set distance maintained as dimensions of the page are changed; and
a second icon representative of a browser window to display the custom digital content, the second icon having a second set of selectable points that are selectable to pin the item of content to the page, which, when pinned, maintain the item of content at a second set distance from a side of the browser window represented by a second selected point, the second set distance maintained as dimensions of the browser window are changed.

12. The computing device of claim 11, wherein the resizing control further comprises a width and height option which may be selected and applied to the item of content displayed on the page in the design surface, wherein when selected to apply to the item of content displayed on the design surface, causes a height and the width of the item of content to automatically change proportionally in response to a change in width of the page.

13. The computing device of claim 11, wherein the resizing control further comprises a browser width option which may be selected and applied to the item of content displayed on the page in the design surface, wherein when selected to apply to the item of content displayed on the design surface, causes the width of the item of content to remain the same as the width of the page.

14. The computing device of claim 11, wherein the first set of selectable points comprise three selectable points that span a horizontal central axis of the pinning control, the three selectable points comprising a left icon, a center icon, and a right icon configured to pin the item of content relative to the left, center, and right of the page, respectively.

15. The computing device of claim 11, wherein the second set distance between the item of content and the second selected point is further maintained when the page is scrolled in the browser window.

16. The computing device of claim 11, wherein selection of a pinning control does not cause the item of content to be resized when the page is resized.

17. In a digital media environment, a method for creating custom digital content in a user interface, the method comprising:
displaying, on a display, the user interface for creating the custom digital content, the user interface including:
a breakpoint bar having multiple breakpoints configured to cause digital content to be resized when selected; and
a toggle for selectively applying characteristics or properties to items of digital content within a particular breakpoint of the multiple breakpoints;
creating a breakpoint to provide a created breakpoint in the breakpoint bar, the created breakpoint representing a width range within which the custom digital content will be displayed on a display device;
displaying an item of content to be part of the custom digital content on a design surface adjacent the breakpoint bar;
while the item of content is selected, receiving an indication of a mode at the toggle in the user interface, a first mode of the toggle causing subsequently applied characteristics or properties to be applied to the item of content in only the created breakpoint, and a second mode of the toggle causing the subsequently applied characteristics or properties to be applied to the item of content across more than one breakpoint of the multiple breakpoints; and
applying a characteristic or property to the item of content, the characteristic or property applied either to the item of content in only the created breakpoint or applied to the item of content across more than one breakpoint of the multiple breakpoints based on the indicated mode of the toggle.

18. The method of claim 17, wherein applying the characteristic or property to more than one breakpoint comprises applying the characteristic or property to all of the multiple breakpoints.

19. The method of claim 17, further comprising:
displaying an additional item of content to be part of the custom digital content on the design surface;
receiving an indication to apply a formatting property to the additional item of content on each breakpoint of the multiple breakpoints; and
applying the formatting property to the additional item of content on each breakpoint of the multiple breakpoints without navigating to each breakpoint of the multiple breakpoints.

20. The method of claim 17, further comprising:
displaying an additional item of content to be part of the custom digital content on the design surface;
receiving an indication to apply an additional formatting property on one other breakpoint of the multiple breakpoints; and
applying the additional formatting property on the one other breakpoint without navigating to the one other breakpoint.
